(19) United States
(12) Patent Application Publication
(10) Pub. No.: US 2026/0362282 A1
(43) Pub. Date: Nov. 12, 2026

(54) ADAPTIVE WIRELESS RESOURCE ALLOCATION FOR DATA CENTER INFRASTRUCTURE

(71) Applicant: MELLANOX TECHNOLOGIES, LTD., Yokneam (IL)

(72) Inventors: Aleksey Dyskin, Haifa (IL); Elad Mentovich, Tel Aviv (IL)

(21) Appl. No.: 19/200,581

(22) Filed: May 6, 2025

(51) Int. Cl. H04W 40/04; H04W 72/52

(52) U.S. Cl. CPC H04W 40/04; H04W 72/52

(57) ABSTRACT

A device and method for dynamic allocation of wireless communication resources in data centers are disclosed. The device includes circuits to receive workload information associated with data traffic, determine resource allocation for wireless communication links between computing devices based on the workload information, configure wireless communication parameters based on the determined resource allocation, and selectively route data traffic through either wireless or wired communication links based on the workload information. The resource allocation may be modified based on monitored performance metrics of the wireless links, including throughput, latency, packet loss, bit error rate, or signal strength. The system prioritizes traffic by routing higher-priority traffic through wired links and lower-priority traffic through wireless links, with additional wireless resources allocated to communication links carrying specific traffic types. This approach improves data center scalability, flexibility, and efficiency while reducing physical infrastructure constraints.

### FIELD OF THE DISCLOSURE

The present disclosure is generally directed toward networking and, in particular, toward networking devices and methods of operating the same.

### BACKGROUND

Data centers have traditionally relied on wired infrastructure to facilitate communication between computing resources, network components, and storage systems. These traditional wired networks typically employ copper cables, optical fibers, and associated hardware components to establish fixed communication paths between data center elements. As data centers have grown in scale and complexity to meet growing computational demands, the corresponding network infrastructure has similarly expanded, creating increasingly complex and densely wired environments that can present significant challenges for deployment, management, and maintenance activities.

The reliance on fixed wired connections within data centers has introduced several operational challenges. Physical cabling requires extensive planning and significant installation time and creates considerable overhead in terms of spatial requirements and cable management. Additionally, network topologies established through physical wiring are inherently static, requiring manual reconfiguration and potential downtime when changes are needed to accommodate evolving workload demands or hardware additions. This inflexibility can be particularly problematic in modern data centers that host dynamic, resource-intensive applications with fluctuating bandwidth, latency, and processing requirements.

Resource allocation in conventional data center networks is primarily accomplished through static provisioning, where network capacity is allocated based on anticipated peak demands. This approach often results in suboptimal resource utilization, as many communication links remain underutilized during normal operation while others may become congested during peak loads or specific workload patterns. Furthermore, traditional data center network planning generally involves overprovisioning to accommodate potential growth and avoid bottlenecks, leading to increased capital expenditures and operational costs associated with installing and maintaining excessive network capacity that may remain unused for extended periods.

### GENERAL DESCRIPTION

In accordance with at least some aspects of the present disclosure, methods, and systems are described for the dynamic allocation of wireless and wired communication resources within data center environments. Techniques described herein enable adaptive reconfiguration of network infrastructure to match changing workload demands without requiring extensive physical modifications or service interruptions. By integrating wireless communication links alongside traditional wired connections, techniques described herein enhance data center networks'flexibility, scalability, and resource efficiency. Data centers are suitable for wireless communication because they are controlled environments with limited access, reducing potential noise problems. The static nature of data centers allows for calibration and optimization of wireless connectivity, as distances are short and fixed.

In one aspect, a resource management system receives workload information associated with data traffic, determines appropriate resource allocations for wireless communication links between computing devices, configures wireless parameters based on fluctuating workload requirements, and selectively routes traffic through wireless or wired communication paths. This adaptive approach allows critical, high-priority traffic to leverage deterministic wired connections while enabling dynamic wireless connectivity for other workloads based on their specific performance needs. The system monitors link performance and adjusts resource allocation and routing decisions in response to changing conditions to maintain an optimal network utilization and application performance.

The described methods and systems address fundamental limitations of traditional data center architectures by reducing dependency on static cabling infrastructure, enabling rapid reconfiguration of communication resources and infrastructure, and providing more efficient resource utilization through dynamic allocation. By implementing techniques for workload classification, intelligent routing, and wireless parameter optimization, aspects described herein can provide flexible, software-defined communication fabric that can adapt to evolving application requirements without manual intervention. This approach reduces operational complexity while enhancing the ability of data centers to scale, reconfigure, and maintain network resources with minimal disruption to services and at low-cost.

Example aspects of the present disclosure provide a device. In some aspects, the device may comprise one or more circuits to: receive workload information associated with data traffic in a data center; determine, based on the workload information, a resource allocation for wireless communication links between computing devices in the data center; configure one or more wireless communication parameters for the wireless communication links based on the determined resource allocation; and selectively route at least a portion of the data traffic through either the wireless communication links or wired communication links based on the workload information.

Aspects include wherein the workload information comprises at least one of: processing requirements; bandwidth requirements; latency requirements; or quality of service requirements.

Aspects include wherein the one or more wireless communication parameters comprise at least one of: frequency allocation; bandwidth allocation; modulation scheme; or transmission power.

Aspects include wherein the one or more circuits are further to: monitor performance metrics of the wireless communication links; and modify the resource allocation based on the monitored performance metrics.

Aspects include wherein the performance metrics comprise at least one of: throughput; latency; packet loss; or signal strength.

Aspects include wherein to selectively route at least a portion of the data traffic, the one or more circuits are further to route traffic of a first priority type through the wired communication links and traffic of a second priority type through the wireless communication links.

Aspects include wherein the one or more circuits are further to prioritize traffic of the second priority type by allocating additional wireless resources to communication links carrying the traffic of the second priority type.

Aspects include wherein the one or more circuits are further to identify the traffic of the second priority type based on at least one of: traffic type; source application; destination application; or quality of service requirements.

Aspects include wherein the computing devices comprise at least one of: a server; a storage device; a network interface controller; or a network switch.

Aspects include wherein the one or more circuits are further to adjust the resource allocation in response to changes in the workload information.

Aspects include wherein to dynamically adjust the resource allocation, the one or more circuits are further to reallocate wireless resources from first communication links to second communication links based on changes in workload priorities.

Aspects include wherein the one or more circuits are further to: maintain a mapping between wireless resources and data center workloads; and update the mapping based on changes in the workload information.

Aspects include wherein to update the mapping, the one or more circuits are further to reassign wireless resources based on at least one of: workload priority changes; network congestion; or performance requirements.

Example aspects of the present disclosure provide a device. In some aspects, the device may comprise one or more circuits to: maintain performance profiles associated with different types of data center workloads; identify, for a data center workload, a performance requirement level from among a plurality of performance requirement levels; allocate, based on the identified performance requirement level, communication resources between wireless communication links and wired communication links for the data center workload; and adjust the allocation of communication resources based on changes in workload performance requirements.

Aspects include wherein data center workloads having higher performance requirement levels are allocated more wired communication resources and data center workloads having lower performance requirement levels are allocated more wireless communication resources.

Aspects include wherein the one or more circuits are further to: detect a change in availability of either the wireless communication links or the wired communication links; and redistribute the communication resources among active data center workloads based on their respective performance requirement levels and the detected change in availability.

Aspects include wherein the one or more circuits are further to: monitor at last one of latency requirements or bandwidth requirements for the data center workload; and switch the data center workload from wireless communication links to wired communication links based on the at least one of the latency requirements or the bandwidth requirements.

Example aspects of the present disclosure provide a system comprising: a data center comprising computing devices interconnected by wired communication links and wireless communication links; and a resource management system to: receive workload information associated with data traffic in the data center; determine, based on the workload information, a resource allocation for the wireless communication links between the computing devices; configure one or more wireless communication parameters for the wireless communication links based on the determined resource allocation; and selectively route at least a portion of the data traffic through either the wireless communication links or wired communication links based on the workload information.

Aspects include wherein the resource management system is further to: monitor performance metrics of the wireless communication links; and modify the resource allocation based on at least one of the monitored performance metrics or power consumption requirements.

Aspects include wherein the resource management system is further to dynamically adjust the resource allocation in response to changes in the workload information.

Additional features and advantages are described herein and will be apparent from the following Detailed Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1A depicts an example data center layout in accordance with at least some aspects of the present disclosure;

FIG. 1B depicts a data center further including wireless communication nodes or devices configured to enable dynamic, wireless connectivity between computing devices or racks within the data center in accordance with at least some aspects of the present disclosure;

FIG. 2A is a block diagram illustrating a system for dynamically allocating wired and wireless communication resources in a data center in accordance with at least some aspects of the present disclosure;

FIG. 2B is a block diagram illustrating example internal components of a resource management circuitry/logic in accordance with at least some aspects of the present disclosure;

FIG. 2C is a block diagram illustrating a traffic classification and prioritization system for selectively routing traffic through either wired or wireless interfaces in accordance with at least some aspects of the present disclosure;

FIG. 3 illustrates a computing environment comprising a network of processing devices interconnected by a fabric, in accordance with at least some aspects of the present disclosure;

FIG. 4 depicts a block diagram of an interconnect device having both wired and wireless ports, in accordance with at least some aspects of the present disclosure;

FIG. 5A illustrates schematic diagrams depicting network topology configurations before and after a workload spike, in accordance with at least some aspects of the present disclosure;

FIG. 5B illustrates a workload classification table that characterizes different data traffic types according to their source, in accordance with at least some aspects of the present disclosure;

FIG. 5C illustrates a link allocation table that tracks active communication resources, in accordance with at least some aspects of the present disclosure;

FIG. 5D illustrates a wireless link monitoring table, in accordance with at least some aspects of the present disclosure;

FIG. 5E illustrates an example of a workload and performance requirement level mapping and communication resource allocations in accordance with aspects of the present disclosure;

FIG. 6A depicts a first portion of a flowchart illustrating a method for dynamically allocating wireless and wired communication resources within a data center environment in accordance with at least some aspects of the present disclosure;

FIG. 6B depicts a second portion of the flowchart illustrating performance monitoring and adaptive reallocation of communication resources in accordance with at least some aspects of the present disclosure;

FIG. 6C depicts a third portion of the flowchart showing the completion path for the resource management process in accordance with at least some aspects of the present disclosure;

FIG. 6D illustrates a flowchart of a method for allocating communication resources within a data center environment, in accordance with at least some aspects of the present disclosure;

FIG. 6E illustrates a flowchart of a method for configuring wireless parameters within a data center environment, in accordance with at least some aspects of the present disclosure;

FIG. 6F illustrates a flowchart of a method for routing traffic within a data center environment, in accordance with at least some aspects of the present disclosure;

FIG. 6G illustrates a flowchart of a method for managing data center network resources, in accordance with at least some aspects of the present disclosure;

FIG. 6H depicts a method for allocating communication resources in accordance with at least one aspect of the present disclosure;

FIG. 7 illustrates a block diagram of a system that includes switching circuitry positioned between first and second sets of devices, in accordance with at least one embodiment;

FIG. 8 illustrates a block diagram of an example system, in accordance with at least one embodiment; and

FIG. 9 illustrates an example data center, in accordance with at least one embodiment.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

Aspects of the present disclosure provide apparatuses, methods, processing systems, and computer-readable mediums for the dynamic allocation of wireless and wired communication resources within data center environments. In some aspects of the present disclosure, systems and methods for managing hybrid network infrastructure in data centers through adaptive resource allocation are described. By analyzing workload characteristics, determining resource requirements, configuring wireless parameters, and selectively routing traffic, aspects described herein may create a more responsive and efficient data center network. This approach enables transitions between wired and wireless communication paths based on real-time demands, reducing dependency on static physical connections while maintaining performance guarantees for critical applications.

Traditional data center networks face technical challenges due to their inherent inflexibility. The static nature of wired infrastructure creates bottlenecks in resource allocation, where communication links may be underutilized during normal operations but insufficient during traffic spikes. Physical reconfiguration requires extensive planning, manual labor, and service disruptions, making it difficult to adapt to changing application requirements. Additionally, dense cabling introduces spatial constraints, cooling inefficiencies, and maintenance complexities that limit scalability and operational agility. These technical limitations become increasingly problematic as modern workloads exhibit greater variability and demand more dynamic resource allocation.

Aspects of the present disclosure address these technical problems through an integrated resource management system that monitors workload requirements and network conditions to optimize communication resources. The system determines appropriate allocations for wireless communication links based on traffic characteristics, configures wireless parameters (such as frequency, modulation, power, and beam direction) to establish optimal connectivity, and implements intelligent routing policies that direct traffic through either wired or wireless paths according to performance needs. For critical applications, the system may prioritize deterministic wired connections, while utilizing flexible wireless links for other workloads or during capacity expansion. The integration of wireless connectivity alongside traditional wired infrastructure enables dynamic reconfiguration of the network topology through software-defined controls rather than physical modifications.

This technical solution offers multiple advantages for data center operations. First, aspects described herein improve resource utilization efficiency by allocating communication capacity based on actual demand rather than peak projections, reducing overprovisioning costs and power consumption. Second, aspects described herein enhance network reconfigurability, enabling adaptation to changing workload patterns without service disruptions or manual intervention. Third, aspects described herein increase scalability by allowing incremental capacity expansion without comprehensive infrastructure overhauls or extensive cabling modifications. Fourth, aspects described herein improve operational resilience by providing alternative communication paths during component failures, scaling, or maintenance activities. Finally, aspects described herein selectively route traffic based on priority and performance requirements, ensuring that critical applications maintain deterministic performance while overall resource utilization is optimized.

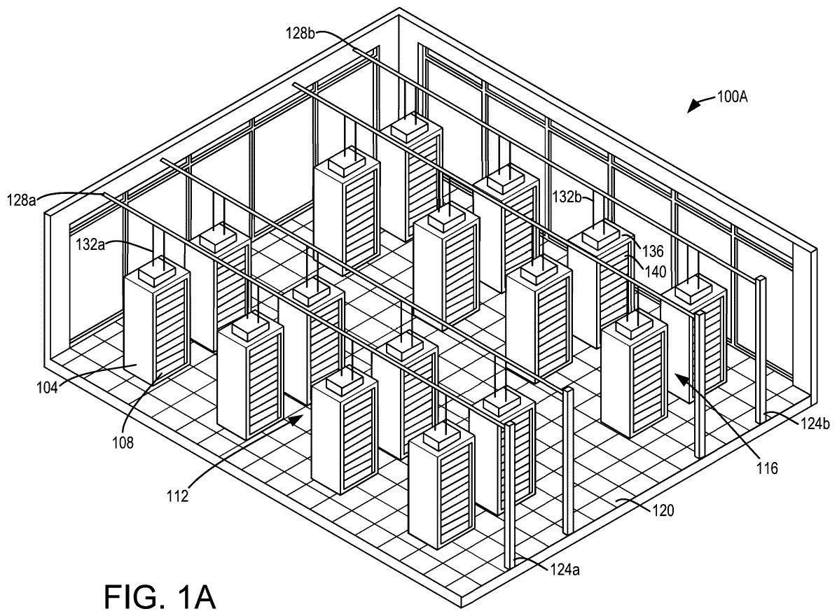

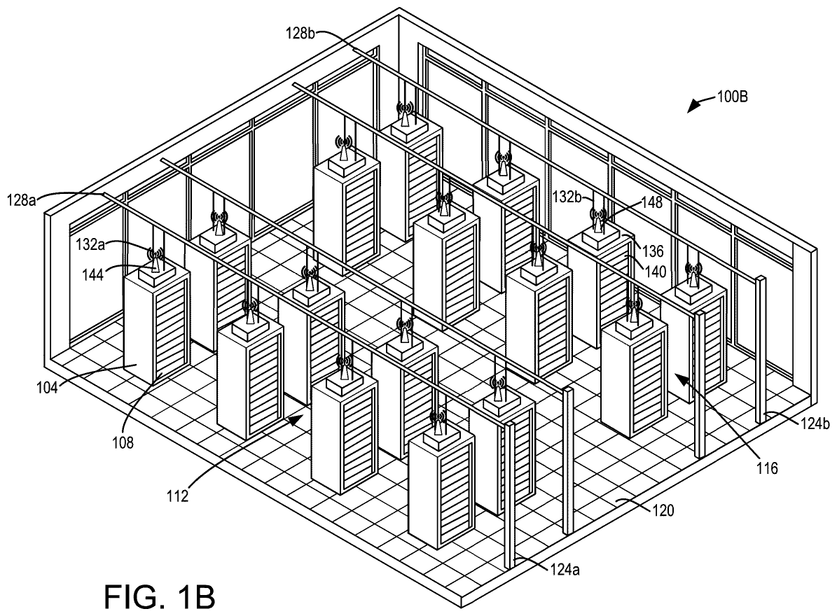

FIG. 1A illustrates an example data center environment 100 incorporating a traditional infrastructure configuration that may be enhanced with the dynamic wireless resource allocation system in accordance with aspects of the present disclosure. The example data center environment 100 may include a plurality of racks 104 arranged in an organized array (or other organization) to facilitate access, cooling, and maintenance. Each rack 104 may house one or more computing devices 108, comprising servers, storage nodes, network switches, routers, or other data processing equipment arranged in a stacked configuration.

The racks 104 may be arranged to define longitudinal aisles 112 and lateral perimeter aisles 116, which may serve multiple purposes within the example data center environment 100. The longitudinal aisles 112 and the lateral perimeter aisles 116 may provide access paths for service personnel to perform maintenance operations, create channels for cooling airflow distribution, and establish organized pathways for cable management. The spatial organization of the longitudinal aisles 112 and the lateral perimeter aisles 116 may contribute to the overall operational efficiency of the data center environment 100, allowing for systematic access to equipment while maintaining appropriate environmental conditions.

The racks 104 may be positioned above a raised floor system comprising individual floor tiles 120. The raised floor design may provide infrastructure benefits that meet one or more requirements of the data center environment 100. Beneath or within the elevated floor space, various support systems may be implemented, including but not limited to plenum airflow designs for cooling air distribution, subfloor conduit for power distribution, and cable routing pathways. The raised floor architecture provides flexibility in infrastructure management while concealing essential utility connections.

Vertical raceway channels 124a and 124b extend from the raised floor to an overhead structure, providing pathways for the vertical routing of various connections throughout the data center environment 100. These vertical raceways 124a, 124b may serve as conduits for wired communication links, power distribution cables, and other utilities such as cooling lines. The vertical raceways 124a, 124b may provide structural support and protection for these connections.

The vertical raceway channels 124a, 124b may connect to horizontal raceway channels 128a and 128b, which span an upper portion of the example data center environment 100. The horizontal raceway channels 128a and 128b may form a structured overhead pathway system for routing cables across the example data center environment 100. By creating this elevated network of raceways, the data center design minimizes floor-level obstructions while establishing a comprehensive infrastructure for interconnecting equipment throughout the example data center environment 100. The horizontal raceways 128a, 128b may incorporate various cable management features such as separators, cable trays, or other organization mechanisms to segregate different connection types properly.

Each rack 104 may connect to the horizontal raceways 128a, 128b via wired connection points 132a and 132b. The wired connection points 132a, 132b may be implemented using various coupling mechanisms such as cable harnesses, patch panels, or modular cabling junctions. The wired connection points 132a, 132b facilitate the integration of the computing devices 108 within each rack 104 to the broader wired backbone of the example data center environment 100. This connectivity architecture establishes fixed communication pathways between equipment, enabling data transfer across the environment according to predetermined routing configurations.

The example data center environment 100 may include a remote server rack 136, which is similarly configured to the other racks 104 but may be located in a different area of the example data center environment 100. The remote server rack 136 may contain at least one example device 140 that participates in a communication system with one or more example devices 108 in one or more other racks 104. In the configuration depicted in FIG. 1A, the example data center environment 100 relies primarily on a fixed cabling infrastructure to maintain network connectivity between racks and other connection points. While this approach provides deterministic high-throughput and low-latency communication pathways, such an approach also presents certain limitations in terms of flexibility and resource utilization. The addition or relocation of devices typically necessitates physical reconfiguration of cabling, which may require scheduled maintenance windows, potential service disruptions, and manual intervention. The extensive cabling requirements can also lead to congestion within raceway channels which may limit future expansion capabilities.

FIG. 1B illustrates an enhanced implementation of the example data center environment 100B, now augmented with wireless connectivity infrastructure designed to complement and selectively replace portions of the traditional wired connections shown in FIG. 1A. This enhanced environment retains the basic structural components described with respect to FIG. 1A, including the racks 104, computing devices 108, aisles 112, 116, floor tiles 120, and raceway channels 124a, 124b, 128a, 128b, while introducing additional wireless communication capabilities.

In some aspects, the example data center environment 100B may incorporate wireless devices 144, 148 (e.g., connection points), enabling dynamic wireless communication links between various components within the environment. The wireless devices 144, 148 may be implemented using various wireless communication technologies suitable for data center applications. The wireless devices 144, 148 may comprise wireless transceivers, directional antenna systems, beam-steerable millimeter wave access points, or other forms of wireless communication hardware capable of establishing reliable connections within the data center context.

The wireless devices 144, 148 may be mounted to structural components of the example data center environment 100B, such as on top of the racks 104, attached to ceiling support structures, or integrated into other existing infrastructure elements. This strategic placement of wireless devices 144, 148 enables the formation of wireless communication links between racks, between individual computing devices 108, or between logical network zones within the data center environment 100. The positioning of the wireless devices 144, 148 may be determined based on coverage requirements, potential interference patterns, and the specific communication needs of different areas within the environment.

While the wireless devices 144, 148 introduce new connectivity capabilities, the example data center environment 100B of FIG. 1B maintains compatibility with the existing wired infrastructure through the wired connection points 132a, 132b. This hybrid approach allows for selective utilization of wireless or wired communication paths based on various factors such as workload characteristics, bandwidth requirements, latency sensitivity, and resource availability. For example, a system may dynamically determine an appropriate communication path for different data flows, potentially shifting certain connections from wired to wireless links or vice versa as conditions change.

The introduction of wireless connectivity in FIG. 1B enhances the example data center environment 100A of FIG. 1A by reducing dependency on fixed cabling infrastructure. Rather than requiring additional physical connections through the vertical raceways 124a, 124b and horizontal raceways 128a, 128b when new capacity is needed, the system can programmatically leverage the wireless devices 144 and 148 to establish new communication links. This capability enables rapid reconfiguration of the network topology through software-defined controls, without necessitating physical access to raceways or manual cable installation procedures.

The remote server rack 136 and its example device 140 can similarly benefit from the wireless connectivity infrastructure. The wireless devices 144, 148 can establish communication links to the remote rack 136 and rack 104, potentially reducing or eliminating the need for extended cable runs to this distant location. This capability demonstrates how the wireless enhancement can simplify connectivity to equipment positioned throughout the example data center environment 100B, regardless of physical proximity to central infrastructure.

In operation, the example data center environment 100B of FIG. 1B may utilize an adaptive resource allocation approach that manages wired and wireless communication links. When changes in workload demand, network congestion, or traffic priority occur, a system can dynamically adjust its connectivity and/or configuration. For example, if a previously underutilized rack experiences increased activity, the system may automatically establish or enhance wireless links to that location via the nearest wireless devices 144, 148, without requiring physical cabling through the raceway channels 124a, 124b, 128a, 128b.

The wireless devices 144, 148 may incorporate beamforming capabilities, adaptive modulation, or dynamic frequency selection to optimize wireless link performance based on environmental conditions and communication requirements. These technologies can create directed, high-throughput connections between specific points within the example data center environment 100B, minimizing potential interference while maximizing spectral efficiency.

The wireless enhancement depicted in FIG. 1B provides several advantages compared to the traditional wired-only approach of FIG. 1A. The example data center environment 100B provides improved scalability by reducing reliance on fixed cabling, as new connections can be established without physical infrastructure changes. The system provides greater reconfiguration flexibility, allowing for rapid adaptation to changing workload patterns. Additionally, maintenance operations can be simplified, as certain connections can be temporarily shifted to wireless paths while physical infrastructure undergoes service or modification.

By combining traditional wired connections via points 132a, 132b and the new wireless capabilities provided by devices 144, 148, the data center environment 100 achieves a hybrid connectivity architecture that can selectively utilize the most appropriate communication medium for different data flows. This approach enables intelligent resource allocation based on actual demand patterns, improving overall efficiency while maintaining performance for critical workloads.

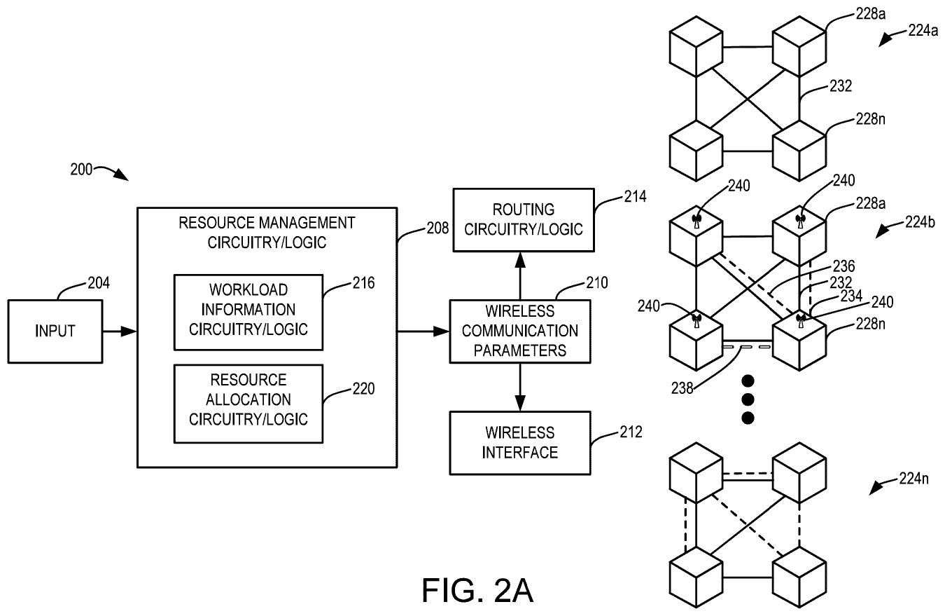

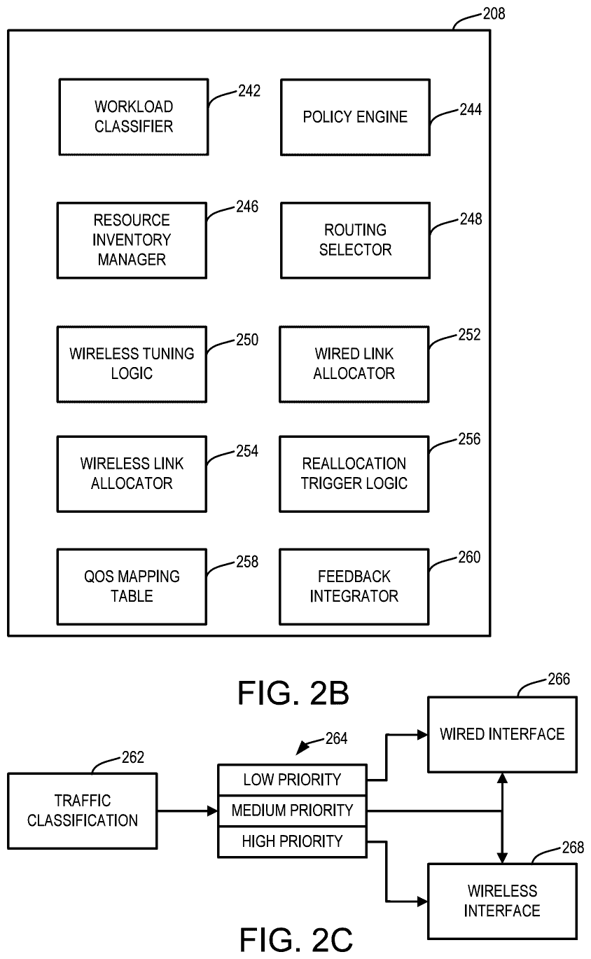

FIG. 2A illustrates a resource management system 200 for dynamically allocating wireless communication resources within a data center environment in accordance with at least one aspect of the present disclosure. The resource management system 200 may comprise various components configured to analyze workload demands, allocate appropriate communication resources, and configure wireless parameters to optimize data center operations.

The resource management system 200 may include an input 204 that represents workload-related information, network telemetry data, and operational parameters for a data center environment. The input 204 may represent various types of data including, but not limited to, current network traffic patterns, bandwidth utilization metrics, application performance requirements, quality of service (QoS) specifications, and real-time monitoring data from computing devices within the data center. Input 204 may be received via one or more data buses, network interfaces, application programming interfaces (APIs), or other suitable mechanisms for receiving operational data from multiple sources throughout a data center infrastructure.

The resource management system 200 may include resource management circuitry/logic 208; the input 204 may be transmitted to the resource management circuitry/logic 208. The resource management circuitry/logic 208 may represent a central processing component of the resource management system 200. The resource management circuitry/logic 208 may evaluate current operating conditions and determine and/or implement one or more resource allocation strategies. The resource management circuitry/logic 208 may be implemented using one or more processors, field-programmable gate arrays (FPGAs), application-specific integrated circuits (ASICs), or combinations thereof, configured with appropriate firmware or software to perform the described functions.

Within the resource management circuitry/logic 208, workload information circuitry/logic 216 may process and analyze the incoming data to characterize current workload demands and traffic patterns. The workload information circuitry/logic 216 may employ pattern recognition algorithms, statistical analysis, machine learning models, or other analytical techniques to identify trends, categorize traffic types, and predict future resource requirements based on historical patterns. The workload information circuitry/logic 216 may identify various workload characteristics, including bandwidth requirements, latency sensitivity, processing dependencies, traffic patterns, and/or quality of service requirements associated with different data flows within the data center.

The resource management circuitry/logic 208 may include resource allocation circuitry/logic 220, which may utilize an analysis provided by the workload information circuitry/logic 216 and determine how communication resources should be allocated across the data center. The resource allocation circuitry/logic 220 may apply resource allocation policies, optimization algorithms, and decision logic to balance competing requirements and ensure efficient utilization of both wired and wireless communication resources. The resource allocation circuitry/logic 220 may implement various allocation strategies such as proportional allocation based on priority levels, dynamic resource reallocation in response to changing conditions, or predictive resource reservation based on anticipated workload changes.

Based on the determinations made by the resource management circuitry/logic 208, the resource management system 200 may output one or more wireless communication parameters 210. The wireless communication parameters 210 may be provided to one or more wireless interfaces 212 and/or routing circuitry/logic 214. The wireless communication parameters 210 may configure operational parameters for wireless communication links within the data center. The wireless communication parameters 210 may include but are not limited to, frequency band selection, bandwidth allocation, transmission power levels, modulation schemes, coding rates, beamforming configurations, and other physical layer settings that influence the performance characteristics of wireless links. The wireless communication parameters 210 may translate high-level resource allocation decisions into specific technical configurations that can be applied to wireless communication hardware, such as a wireless interface 212.

The wireless communication parameters 210 interfaces with wireless interface 212, representing one or more hardware components for establishing and maintaining wireless connections within the data center. The wireless interface 212 may comprise radio frequency transceivers, antenna arrays, signal processing components, and associated control electronics capable of implementing the parameter configurations specified by the wireless communication parameters 210. The wireless interface 212 may support multiple wireless communication technologies, including, but not limited to, millimeter wave communications, Wi-Fi, Bluetooth, ultra-wideband, or custom protocols optimized for data center environments.

The routing circuitry/logic 214 may determine one or more paths (e.g., optimal paths) for data traffic through a network fabric based on resource allocation decisions and wireless communication parameters 210. The routing circuitry/logic 214 may implement adaptive routing algorithms that consider current network conditions, link availability, and workload priorities when selecting between available wired and wireless paths. The routing circuitry/logic 214 may interface with network switches, routers, and other communication infrastructure to reconfigure the network topology in response to changing demands or resource availability.

The resource management system 200 can dynamically manage multiple network communication configurations as illustrated by configurations 224a, 224b, and 224n on the right side of FIG. 2A. Each configuration represents a different arrangement of connectivity between computing devices 228a-228n within the data center.

Configuration 224a depicts computing devices 228a-228n interconnected via wired links 232. The wired links 232 may include various physical connections such as copper cables, optical fibers, or backplane traces providing fixed, high-bandwidth, low-latency communication paths between devices. The wired links 232 may implement various communication protocols suitable for data center environments such as remote direct memory access (RDMA) over, including but not limited to Ethernet (e.g. converged Ethernet for lossless connections), InfiniBand, Fibre Channel, or proprietary interconnect technologies.

Configuration 224b illustrates the same or similar computing devices 228a-228n interconnected through wireless links 234 and 236. These wireless connections are facilitated by antenna or transceiver elements 240 mounted on, integrated into, or otherwise accessible by each device 228a-228n. The antenna elements or transceiver elements 240 may include directional antennas, phased array systems, or other radio frequency components capable of establishing device-to-device wireless links. Wireless links 234 and 236 may operate using different frequencies, modulation schemes, or protocols to accommodate varying communication requirements between different pairs of devices.

Configuration 224n represents a hybrid connectivity scenario where wireless links 238 are dynamically configured with different parameters to support specific workload requirements or environmental conditions. The configuration 224n depicts the capability of the system to selectively apply different wireless communication strategies across the data center based on workload characteristics, resource availability, or performance requirements. The resource management system 200 can transition between configurations in real-time and provide a flexible reconfiguration of the data center network fabric without requiring physical recabling or extensive manual intervention. Accordingly, the resource management system 200 can adapt to changing workload demands, optimize resource utilization, and maintain service continuity during maintenance or scaling operations.

FIG. 2B provides additional details of the internal components within the resource management circuitry/logic 208 depicted in FIG. 2A. In some aspects, a workload classifier 242 may represent a first-stage analysis component that evaluates incoming workload information to categorize traffic based on various characteristics. The workload classifier 242 may employ multiple classification techniques to determine the nature and requirements of different data flows. Example classification techniques include but art not limited to deep packet inspection, flow analysis, application fingerprinting, and metadata examination to determine the nature and requirements of different data flows. The workload classifier 242 may identify and tag traffic according to application type (e.g., database transactions, web services, machine learning training, storage operations), priority level, latency sensitivity, bandwidth requirements, or other relevant attributes. The workload classifier 242 may implement various classification algorithms, including but not limited to, statistical methods, machine learning models, or rule-based systems to identify and categorize workloads even as application patterns evolve accurately. The classification results generated by workload classifier 242 may be used by downstream components to inform resource allocation decisions. Such classification results may include, but are not limited to traffic type identifiers, priority levels, performance requirements, and other metadata.

In some aspects, policy engine 244 may apply organizational guidelines, service-level agreements, and administrative priorities to the resource allocation process. The policy engine 244 may maintain and interpret a set of rules defining how resources should be allocated under different conditions and for different workloads. Such policies may specify relative priorities between workloads, minimum performance thresholds, resource reservation requirements, or constraints on when and how wireless resources can be utilized.

The policy engine 244 may support hierarchical policy structures where different policies apply at various levels of the data center infrastructure (e.g., rack-level, pod-level, or data center-wide). The policy engine 244 may also implement dynamic policy selection based on time of day, current operational status, or business priorities. By interpreting the policies in the context of current conditions, the policy engine 244 may guide other components regarding resource allocation strategies that align with organizational objectives.

In some aspects, the resource inventory manager 246 may maintain a comprehensive real-time view of communication resources available within the data center. The resource inventory manager 246 may track the status, capacity, and performance characteristics of wired and wireless communication links throughout the infrastructure. This may include monitoring link status, available bandwidth, utilization levels, and error rates across physical connections for wired resources. For wireless resources, the inventory may track available channels, frequency allocations, signal quality metrics, interference levels, and transceiver capabilities. The resource inventory manager 246 may receive updates from network monitoring systems, device agents, or direct telemetry feeds to represent the communication infrastructure's current state accurately. A real-time inventory may provide one or more other components with information to make informed decisions based on actual resource availability rather than static configurations.

In some aspects, the routing selector 248 may determine an optimal path for data traffic through the network infrastructure based on workload requirements and resource availability. The routing selector 248 may implement various routing algorithms, including shortest path, least congested path, or policy-based routing, to identify the most appropriate communication path for each data flow. When multiple paths are available between endpoints (e.g., wired and wireless), the routing selector 248 may evaluate factors such as current link utilization, measured latency, reliability metrics, and workload priorities to select the optimal routing strategy. The routing selector 248 may generate routing configurations for network devices, flow table entries for software-defined networking controllers, or other control instructions that implement the selected routing decisions within the physical infrastructure. The routing selector 248 may reevaluate routing decisions as network conditions or workload requirements change.

In some aspects, wireless tuning logic 250 may configure and optimize wireless communication parameters to achieve desired performance characteristics. The wireless tuning logic 250 may translate high-level resource allocation decisions into specific technical configurations for wireless communication links. The wireless tuning logic 250 may determine suitable parameters such as channel selection, bandwidth allocation, modulation scheme, coding rate, transmission power, beamforming weights, and other physical layer settings influencing wireless link performance. The wireless tuning logic 250 may implement adaptive optimization techniques that adjust wireless parameters in response to measured performance metrics, interference conditions, or changing workload requirements. For example, if a wireless link experiences interference or signal degradation, the wireless tuning logic 250 may automatically adjust frequency allocation, switch to a more robust modulation scheme, or increase transmission power to maintain reliable communication. Similarly, if a workload requires additional bandwidth, the wireless tuning logic 250 may reallocate spectral resources to provide greater capacity where needed.

In some aspects, the wired link allocator 252 may manage the assignment of workloads to available wired communication paths within the data center. The wired link allocator 252 may determine which data flows should be routed over physical connections based on workload requirements, link availability, and current utilization levels. When multiple workloads compete for limited wired resources, the wired link allocator 252 may apply prioritization rules, fairness mechanisms, and/or reservation policies to allocate capacity appropriately. The wired link allocator 252 may interface with network management systems, software-defined networking controllers, or switch configuration interfaces to implement allocation decisions within the physical infrastructure. The wired link allocator 252 may monitor link utilization and performance metrics to identify potential congestion or underutilization and adjust allocations accordingly.

In some aspects, the wireless link allocator 254 manages the dynamic creation, configuration, and teardown of wireless communication links between endpoints in the data center. The wireless link allocator 254 may determine which devices should establish wireless connections, when those connections should be activated or deactivated or removed, and what capacity should be allocated to each link. Unlike wired connections, which typically have fixed physical topologies, wireless links can be established or reconfigured dynamically without physical changes to the infrastructure. The wireless link allocator 254 may implement various allocation strategies including on-demand link establishment, scheduled wireless resource reservation, or persistent wireless overlay networks that supplement the wired infrastructure. When allocating wireless resources, the wireless link allocator 254 may evaluate factors such as physical proximity between devices, potential interference patterns, antenna capabilities, and workload prioritization.

In some aspects, the reallocation trigger logic 256 may evaluate whether current resource allocations remain optimal given changing conditions within the data center. The reallocation trigger logic 256 may monitor various metrics to identify situations where the current resource allocation may no longer be appropriate. Such metrics may include but are not limited to link utilization, queue depths, latency measurements, error rates, and workload characteristics, to identify situations where the current resource allocation may no longer be appropriate. When predefined thresholds are crossed or significant changes are detected, the reallocation trigger logic 256 may quickly initiate a resource reallocation process by reintroducing wired paths or boost wireless resources to ensure data flows have the necessary capacity, all while reducing downtime and making the entire network more efficient. The reallocation trigger logic 256 may implement various triggering mechanisms including threshold-based triggers (e.g., when utilization exceeds 80%), trend-based triggers (e.g., when latency is steadily increasing), or event-based triggers (e.g., when a new high-priority workload is detected). The reallocation trigger logic 256 may provide adaptive behavior while avoiding excessive reconfiguration overhead by identifying appropriate moments to reconsider resource allocations.

In some aspects, the QoS mapping table 258 maintains associations between workload requirements and communication paths or service classes that can satisfy those requirements. The QoS mapping table 258 may define how different quality of service needs (e.g., bandwidth guarantees, latency bounds, reliability levels) map to specific communication options within the data center. This mapping may include definitions of service classes with particular performance characteristics or directly associate workload types with preferred communication media or protocols. The QoS mapping table 258 may be structured as a multi-dimensional lookup table that considers various factors when determining appropriate communication options. Such factors may include but are not limited to, workload type, priority level, and performance requirements when determining appropriate communication options. QoS mapping table 258 may provide a structured framework for translating application-level requirements into network-level resource allocations.

In some aspects, the feedback integrator 260 may process performance measurements and operational metrics from the data center environment to inform ongoing resource allocation decisions. The feedback integrator 260 may collect data from network monitoring systems, device telemetry, and application performance measurements to evaluate current resource allocations'effectiveness and identify improvement opportunities. This feedback loop enables the system to learn from operational experience and continuously refine its allocation strategies. The feedback integrator 260 may implement various analysis techniques to extract actionable insights from the collected metrics. Such techniques may include but are not limited to trend analysis, anomaly detection, correlation analysis, and/or performance modeling, to extract actionable insights from the collected metrics.

FIG. 2C illustrates a traffic prioritization and interface selection system in accordance with at least one aspect of the present disclosure. The system provides an example of a mechanism for selectively routing data center traffic through wired and/or wireless communication interfaces based on traffic characteristics and priority levels. The traffic classification block 262 may analyze incoming data flows and categorize the incoming data flows according to predetermined classification criteria. The traffic classification block 262 may employ techniques such as deep packet inspection, header analysis, flow characteristic evaluation, and application fingerprinting to determine the nature and requirements of each data flow. The classification may consider source and destination identifiers, protocol information, bandwidth requirements, latency sensitivity, and workload criticality.

Based on the analysis performed by block 262, data flows may be assigned to appropriate priority levels within the priority queue block 264. As depicted in FIG. 2C, block 264 establishes three priority levels: low priority, medium priority, and high priority queues. The low-priority queue may accommodate traffic tolerant of latency or bandwidth limitations, such as background data transfers or maintenance operations. The medium priority queue handles traffic with moderate performance requirements representing typical operational data flows. The high-priority queue contains traffic with stringent performance requirements or critical operational importance, such as latency-sensitive transactions or control plane traffic.

Following prioritization, the system selectively routes traffic to one or more of the wired interface 266 or the wireless interface 268. The wired interface 266 represents the physical, cable-based communication infrastructure within the data center, which may provide deterministic performance characteristics including high bandwidth capacity, low latency, and high reliability. The wireless interface 268 represents the radio frequency-based communication infrastructure, providing flexibility in connectivity without physical cabling constraints.

As the connection paths depict, high-priority traffic may be preferentially routed through the wired interface 266 to leverage its deterministic performance characteristics. Medium-priority traffic may be routed through either interface depending on current conditions and resource availability. Low-priority traffic may be preferentially directed toward the wireless interface 268, mainly when wired resources are in high demand.

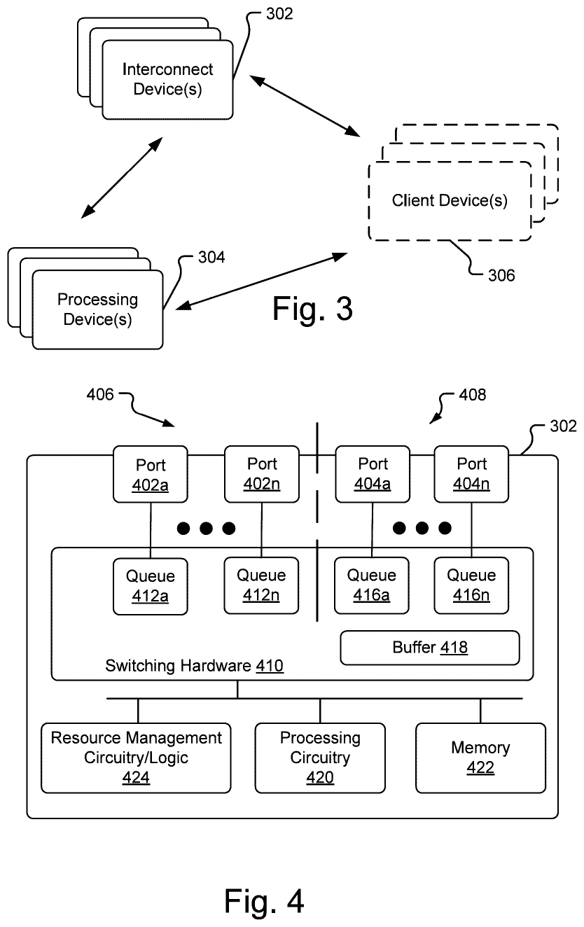

As illustrated in FIG. 3, a computing environment 300 as described herein may include a network of processing devices 304 which may be interconnected by a fabric. A fabric, as described herein, may include one or more interconnect devices 302 and/or one or more processing devices 304. The one or more interconnect devices 302 may be in communication with the processing devices 304 as well as one or more other computing systems such as client devices 306. Such a network of processing devices 304 and interconnect devices 302 may be useful in various settings, from data centers and cloud computing infrastructures to AI systems.

Processing devices 304 may be computing units, such as personal computers, servers, or other computing devices, and may be responsible for executing applications and performing data processing tasks. Processing devices 304, as described herein, can range from servers in a data center to desktop computers in a network, or to devices such as internet of things (IoT) sensors and smart devices.

One or more of the processing devices 304 may include one or more processing circuits, such as GPUs, central processing units (CPUs), application-specific integrated circuits (ASICs), field programmable gate arrays (FPGAs), or other circuitry capable of performing computations, as well as memory and storage resources to run software applications, handle data processing, and perform specific tasks as needed. In some implementations, processing devices 304 may also, or alternatively, include hardware, such as GPUs for handling computationally intensive tasks for machine learning, artificial intelligence (AI) workloads, or other complex processes.

For example, processing devices 304 may operate as a high-performance computing (HPC) cluster. A cluster of processing devices 304 may comprise numerous interconnected servers, each equipped with powerful CPUs and/or GPUs. The processing devices 304 may provide computational horsepower for, as an example, training large-scale AI models or running complex scientific simulations. For AI and machine learning tasks, the processing devices 304 may comprise one or more GPUs or other processing circuitry which may be capable of handling parallel processing requirements of neural networks and other applications.

Interconnect devices 302, as described in greater detail herein, may enable communication between processing devices 304 and/or client devices 306. An interconnect device 302 may be, for example, a network switch, a network interface controller (NIC), or other device capable of receiving and sending data, and may act as a central node in the network. Interconnect devices 302 may be wired in a topology including spine switches and top-of-rack (TOR) switches for example. Interconnect devices 302 may be capable of receiving, processing, and forwarding data, e.g., packets, to appropriate destinations within a network. In some aspects, such destinations may include but are not limited to processing devices 304 and/or client devices 306. In some implementations, an interconnect device 302, as described herein, may be included in a switch box, a platform, or a case that may contain one or more interconnect devices 302 and one or more power supply devices.

In some implementations, one or more processing devices 304 may be connected to one or more ports of one or more interconnect devices 302 via network cables. In some aspects, one or more processing devices 304 may be wirelessly connected to one or more ports of one or more interconnect devices 302. Processes, such as applications, executed by processing devices 304 may involve transmitting data to nodes of the network, such as to other processing devices 304 and/or to client devices 306. Data may flow through the network of processing devices 304 and interconnect devices 302 using one or more protocols such as transmission control protocol (TCP), user datagram protocol (UDP), or Internet protocol (IP), for example. One or more interconnect devices 302 may, upon receiving data from a processing device 304 or another interconnect device 302, examine the data to identify a destination for the data and route the data through the network.

Client devices 306, as described herein, may refer to computing devices that perform AI-related, research-related, and/or other processor-intensive tasks. To manage substantial computational loads and data throughput that may be needed for such applications, client devices 306 may utilize one or more processing devices 304. Examples of client devices 306 include but are not limited to workstations and personal computers used by researchers, data scientists, and/or professionals for developing, testing, and/or executing AI models and research simulations. While a client device 306 may be equipped with one or more CPUs and/or GPUs, one or more client devices 306 may need additional computational resources to perform complex tasks in an efficient manner. By interacting with processing devices 304, client devices 306 may be enabled to perform functions such as, for example, training machine learning models, performing data processing, running simulations, analyzing large datasets, and/or performing complex data processing tasks, such as data mining, pattern recognition, and/or predictive modeling.

FIG. 4 depicts additional details of an interconnect device 302 in accordance with examples of the present disclosure. In some aspects, an interconnect device 302 may include a plurality of ports 402a-402n/404a-404n, switching hardware 410, processing circuitry 420, memory 422, and resource management circuitry/logic 424. The interconnect device 302 may include one or more ports 402a-202n/404a-404n configured to send and receive data in the form of packets, frames, and/or other units of information. The ports 402a-402n/404a-404n may be referred to as hardware ports, representing physical interfaces capable of handling communication through copper, fiber, or radio frequency links. Ports 402a-402n (wired) support transmission over physical cabling, while ports 404a-404n (wireless) support wireless communication protocols suitable for high-throughput data center environments. A “hardware port” may refer to a physical interface on a network switching device (also referred to as a switch and a network switch herein), such as an Ethernet or fiber-optic port, through which network packets are transmitted and received over physical media. A hardware port may be distinct from a “logical port,” which may refer to a software-defined endpoint identified by a numerical designation used to facilitate protocol-specific communication between networked devices at the transport or application layer. Although embodiments are discussed primarily involving hardware ports, embodiments of the present disclosure may also be applied to logical ports.

In some aspects, each port 402a-402n may support high-speed data transfers over physical cabling, such as copper or fiber-optic cables. In certain aspects, one or more ports 404a-404n may be compatible with one or more wireless transceivers. In some aspects, the ports 404a-404n may refer to a physical radio interface, logical port or SSID tied to a virtual access point, and/or a beamformed direction link to a specific destination node. The ports 402a-402n/404a-404n may be configured to accommodate one or more communication standards and protocols, including Ethernet, InfiniBand, and/or proprietary link-layer protocols, thereby enabling flexible deployment in diverse networking environments. Each port 402a-402n/404a-404n may dynamically switch between ingress and egress functionality or operate in dedicated ingress or egress modes, depending on an overall configuration and management policies configured via, for example, software or firmware.

In some aspects, each port 402a-402n/404a-404n may incorporate physical layer devices (PHYs) and/or logic that perform signal encoding/decoding, clock and data recovery, and other low-level operations. These components may be implemented in ASICs, FPGAs, or discrete modules. Ports may also include local buffers or queues, queues 412a-412n for wired ports and queues 416a-416n for wireless ports, to temporarily store data before switching. In certain implementations, the port-specific buffers or queue 412a-412n/416a-416n may be referred to as on-chip or external memory elements. The on-chip or external memory elements may work with larger shared resources, such as buffer 418, to provide efficient queuing and management of traffic. The configuration and operational status of each port 402a-402n/404a-404n, such as speed, duplex settings, or active/inactive state, may be monitored by the processing circuitry 420. Furthermore, ports 402a-402n/404a-404n may provide status indicators or counters (e.g., for packets transmitted or dropped) that can be accessed by higher-level software for analytics or troubleshooting. The ports 402a-402n/404a-404n may provide one or more interface points that connect the interconnect device 302 to external devices, thereby enabling one or more traffic management, congestion management, and/or load balancing techniques described herein. In some aspects, one or more queues 416a-416n may be utilized for per-client buffering, traffic prioritization, MAC-layer retransmissions, and/or QoS and airtime fairness enforcement.

In some aspects, the one or more of the queues 412a-412n/416a-416n may be configured to temporarily hold data units (e.g., packets) awaiting transmission or processing. In some implementations, the one or more queues 412a-412n/416a-416n may be implemented in hardware as dedicated first-in-first-out (FIFO) buffers, circular buffers, or other structures capable of being dynamically partitioned. For example, in an implementation where the interconnect device 302 supports multiple priority levels, high-priority traffic (such as real-time video or voice data) may be assigned to a dedicated queue with expedited processing, while lower-priority data (such as background file transfers) may be placed in another queue with a best-effort service policy.

The number of queues 412a-412n/416a-416n can vary according to one or more configurations. For example, an implementation may assign a separate queue to each port 402a-402n/404a-404n. In other implementations, one or more queues 412a-412n/416a-416n may be allocated based on traffic classes, priority levels, or virtual channels. In some aspects, one or more queues 412a-412n/416a-416n collectively perform flow-control tasks by absorbing bursts of incoming data and releasing them at a rate consistent with downstream capacity. For instance, in a data center environment running HPC applications, each queue 412a-412n/416a-416n may correspond to a particular traffic type, such as compute, storage, or management, and selectively throttle certain types of traffic whenever multiple ports ramp up simultaneously. By grouping traffic this way, a system can process a burst of new data transmissions without saturating downstream resources.

In some aspects, the switching hardware 410 may include one or more integrated circuits, multiplexers, crossbar fabrics, or other data-forwarding components arranged to direct incoming data from a port (e.g., one or more ports 402a-402n/404a-404n) to one or more destination ports based on switching logic for Layer 2 forwarding and/or routing logic for Layer 3 processing. In some implementations, the switching hardware 410 may operate at line-rate speeds (i.e., processing packets at the maximum theoretical speed of the network interface), ensuring minimal latency while maintaining reliable throughput. The switching hardware 410 may incorporate dedicated forwarding tables or pipelines that analyze header information, such as media access control (MAC) addresses for Layer 2 switching, virtual local area network (VLAN) tags, or network-layer identifiers such as Internet Protocol (IP) addresses for Layer 3 routing, to determine how best to forward each data unit within the interconnect device 302. In addition, the switching hardware 410 may utilize programmable match-action stages (i.e., processing pipeline stages that compare incoming packet fields against predefined patterns and execute corresponding actions), enabling adaptation to evolving network needs through software-defined updates. For instance, a reconfiguration of the switching hardware 410 may implement different flow-control strategies, advanced monitoring capabilities, or security filters without needing a redesign of the switching hardware 410.

In some aspects, the switching hardware 410 may also coordinate with the resource management circuitry/logic 424 to adapt how the interconnect device 302 uses its wired and wireless communication resources. The resource management circuitry/logic 424 may assess link states, workload demands, and performance metrics to shift traffic between interfaces as needed. For example, a congestion spike at a wired port may trigger offloading of low-priority traffic to available wireless ports. Alternatively, the network fabric may scale wireless capacity by dynamically configuring additional wireless links, reallocating spectral resources, or enabling multi-stream connections.

The processing circuitry 420 may comprise one or more processors, microcontrollers, digital signal processors (DSPs), or dedicated ASIC blocks configured to manage system-level operations of the interconnect device 302. In some implementations, the processing circuitry 420 may execute firmware stored in memory 422 to maintain routing tables, manage port configuration parameters (e.g., enabling or disabling specific ports 402a-402n/404a-404n), and apply quality-of-service policies. The processing circuitry 420 can interface with higher-level management tools, such as a network orchestration platform or a cloud-based controller, to convey telemetry data or receive updated resource management circuitry/logic on the fly. By offloading some decisions to the switching hardware 410, the processing circuitry 420 can remain available for more complex tasks, including congestion analytics, device configuration, and other diagnostic tasks (e.g., performing debugging of flow-control counters or verifying compliance with service-level agreements). Accordingly, the interconnect device 302 can maintain a high level of throughput while still providing congestion management and adaptive routing functionality.

The interconnect device 302 may include memory 422 that may utilize one or more storage technologies, such as DRAM, SRAM, TCAM, or flash. In some aspects, DRAM may store large routing tables or buffering data, SRAM could serve as high-speed scratchpads for real-time operations, while TCAM could facilitate rapid lookups for routing or security rules. Regardless of the specific technology, memory 422 can be used to make configuration parameters, firmware images, and runtime data structures readily accessible to the processing circuitry 420. In certain aspects, memory 422 may house a lightweight operating system or embedded software stack that manages hardware resources and provides an interface for remote configuration and updates. Moreover, memory 422 may enable virtualization capabilities, allowing multiple logical partitions (or “slices”) of the device to operate independently, which may be useful in large-scale data centers or cloud environments, where different tenants or workloads may need isolated resources and custom flow-control settings.

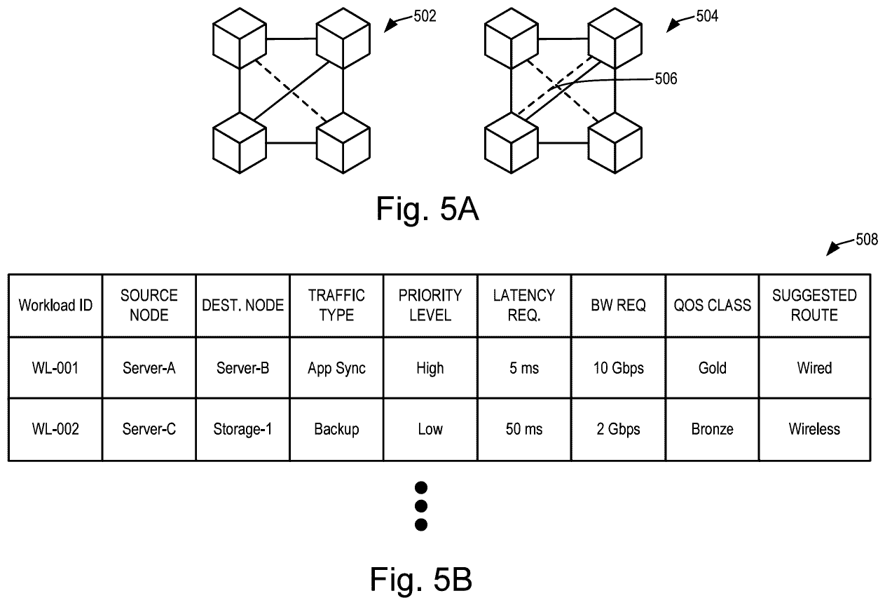

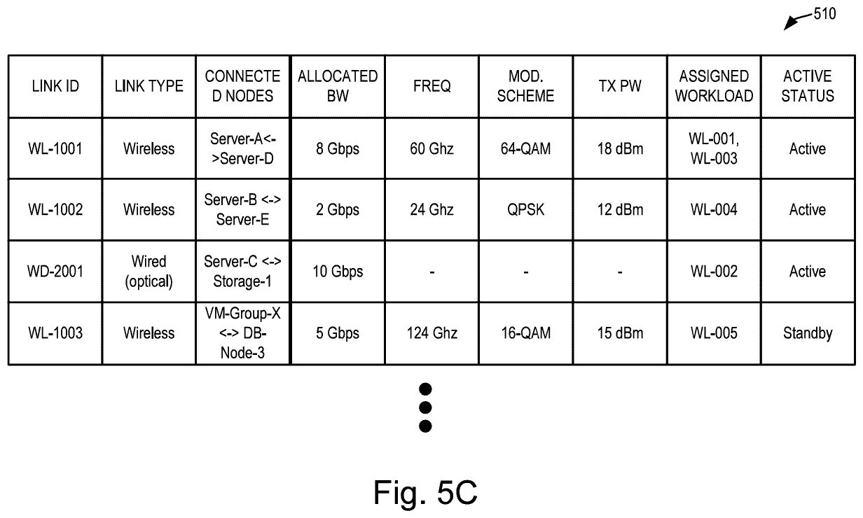

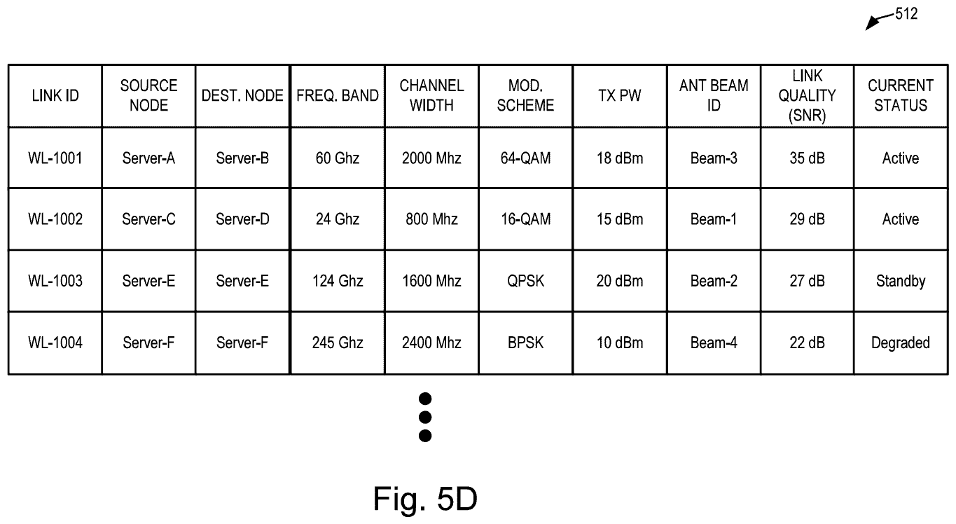

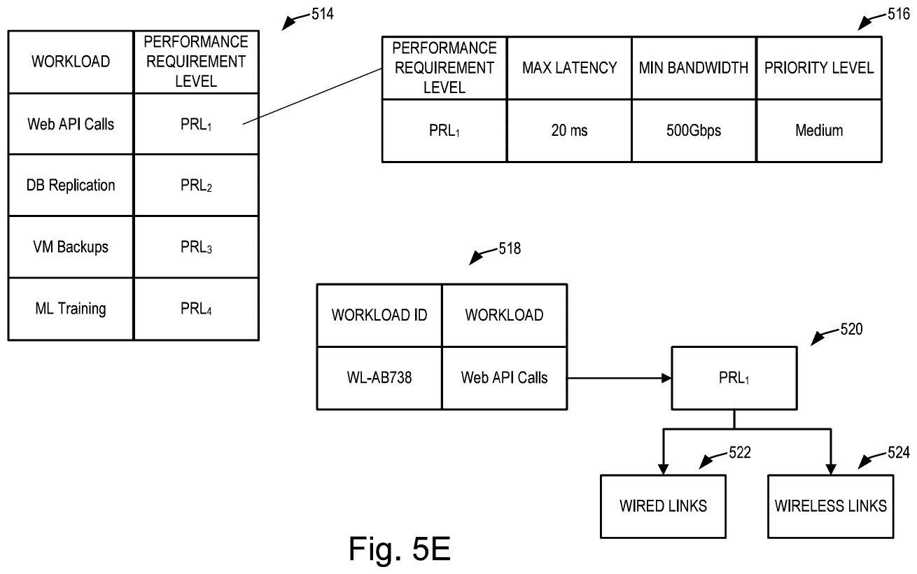

FIG. 5A illustrates schematic diagrams 502 and 504 showing network topology configurations before and after a workload spike in accordance with at least some aspects of the present disclosure. In some aspects, diagram 502 depicts a pre-workload spike configuration with four computing nodes arranged in a square topology. In this initial state, solid lines represent established wired connections between adjacent nodes, while dashed lines indicate wireless communication links. This configuration may represent a data center's baseline state during normal operational conditions, where primary connectivity is maintained through the wired infrastructure and/or a mix of wireless infrastructure. In some examples, additional wireless capabilities remain available but may be inactive.

In some aspects, diagram 504 illustrates the post-workload spike configuration of the same network after detecting increased resource demands. In response to the workload spike, the system has activated connection 506, which represents a wireless link established between two diagonally positioned nodes. The connection 506 has been dynamically provisioned to accommodate the increased traffic demands, providing additional communication capacity without requiring changes to the physical cabling infrastructure. This adaptive response demonstrates how the system can rapidly reconfigure communication resources to maintain performance during fluctuating workload conditions, enabling scalability without manual intervention or service disruption.

FIG. 5B illustrates a workload classification table 508 that may be maintained by the resource management circuitry/logic 208 of FIG. 2, workload information circuitry/logic 216 of FIG. 2, and/or the resource management circuitry/logic 424 of FIG. 4 to inform routing decisions between wired and wireless communication paths in accordance with at least some aspects of the present disclosure. The workload classification table 508 may include multiple data fields that characterize different workloads and their associated communication requirements. The workload classification table 508 maintains information to enable the system to make intelligent routing decisions by matching workload characteristics with appropriate communication resources.

The workload classification table 508 may include a “Workload ID” field that provides a unique identifier for each workload or data flow within the data center environment. For example, the table illustrates workload identifiers “WL-001” and “WL-002” corresponding to distinct operational tasks or application processes. The workload classification table 508 may include “SOURCE NODE” and “DEST. NODE” fields identifying the origin and destination points for the workload traffic. For example, “Server-A” is identified as the source for workload “WL-001” with “Server-B” as its destination, while “Server-C” serves as the source for workload “WL-002” with “Storage-1” as its destination.

The “TRAFFIC TYPE” field may categorize the nature of the data being transmitted, such as “App Sync” for workload “WL-001” and “Backup” for workload “WL-002”. This characterization helps the system understand the operational context and performance expectations associated with each data flow. The “PRIORITY LEVEL” field may indicate the relative importance of each workload, with values such as “High” for workload “WL-001” and “Low” for workload “WL-002”. This prioritization enables the system to allocate communication resources appropriately during periods of contention.

The “LATENCY REQ.” field may specify the maximum acceptable delay for data transmission, such as “5 ms” for workload “WL-001” and “50 ms” for workload “WL-002”. These latency requirements may influence routing decisions, as certain applications may have strict timing constraints that favor deterministic wired connections, while others can tolerate higher variability. The “BW REQ.” field indicates the bandwidth needs for each workload, expressed in units such as gigabits per second (Gbps). For example, workload “WL-001” requires “10 Gbps” while workload “WL-002” requires “2 Gbps”.

The “QOS CLASS” field associates each workload with a predefined service level, such as “Gold” for workload “WL-001” and “Bronze” for workload “WL-002”. These classes may correspond to specific performance guarantees and resource allocation policies within the data center. In some aspects, a “SUGGESTED ROUTE” field may indicate a preferred communication medium for each workload based on its characteristics. For example, the high-priority, low-latency “App Sync” workload “WL-001” is assigned a “Wired” route, while the lower-priority “Backup” workload “WL-002” is assigned a “Wireless” route.

FIG. 5C illustrates a link allocation table 510 that tracks the allocation of communication resources across both wired and wireless links in accordance with at least some aspects of the present disclosure. The link allocation table 510 maintains information associated with active connections within the data center, enabling efficient management and monitoring of resource utilization. In some aspects, the link allocation table 510 may be maintained by the resource management circuitry/logic 208 of FIG. 2, the workload information circuitry/logic 216 of FIG. 2, the resource management circuitry/logic 424 of FIG. 4, and/or other components described herein. The link allocation table 510 includes a “LINK ID” field that uniquely identifies each communication link within the data center infrastructure. For example, the table shows wireless links with identifiers “WL-1001”, “WL-1002”, and “WL-1003”, and a wired link with identifier “WD-2001”. The “LINK TYPE” field specifies the communication medium for each link, such as “Wireless” or “Wired (Optical)”. This classification reflects the physical implementation of each connection within the data center environment.

The “CONNECTED NODES” field may identify the endpoints of each communication link, indicating which devices or racks are interconnected. For example, link “WL-1001” connects “Server-A” with “Server-D”, while link “WD-2001” connects “Server-C” with “Storage-1”. These connections may span various distances and network topology positions within the data center. The “ALLOCATED BW” field may specify the bandwidth capacity assigned to each link, such as “8 Gbps” for link “WL-1001” and “10 Gbps” for link “WD-2001”. These allocations reflect the system's determination of appropriate resource levels based on workload demands.

For wireless links, the table may include additional configuration parameters. The “FREQ” field indicates the frequency band utilized for wireless transmission, such as “60 GHz” for link “WL-1001” and “28 GHz” for link “WL-1002”. These frequency selections may be based on factors such as required bandwidth, interference patterns, and distance between nodes. The “MOD. SCHEME” field specifies the modulation technique employed for data encoding, such as “64-QAM” for link “WL-1001” and “QPSK” for link “WL-1002”. These modulation choices reflect trade-offs between data rate, spectral efficiency, and error resilience.

The “TX PW” field indicates the transmission power level configured for each wireless link, expressed in decibel-milliwatts (dBm). For example, link “WL-1001” operates at “18 dBm” while link “WL-1002” operates at “12 dBm”. These power settings may be dynamically adjusted to maintain signal quality while minimizing interference with other links. The “ASSIGNED WORKLOAD” field maps active workloads to their corresponding communication links. For example, workloads “WL-001” and “WL-003” are assigned to link “WL-1001”, while workload “WL-002” is assigned to link “WD-2001”. This mapping enables tracking of how resources are being utilized to support specific operational tasks.

The “ACTIVE STATUS” field indicates the current operational state of each link, such as “Active” or “Standby”. For example, links “WL-1001”, “WL-1002”, and “WD-2001” are marked as “Active”, while link “WL-1003” is in “Standby” mode. This status information allows the system to monitor available capacity and quickly activate standby links when additional resources are needed.

FIG. 5D illustrates a wireless link monitoring table 512 that provides detailed performance metrics and configuration parameters for wireless connections within the data center in accordance with at least some aspects of the present disclosure. The wireless link monitoring table 512 provides information for real-time assessments of link quality and supports adaptive optimization of wireless resources. In some aspects, the wireless link monitoring table 512 may be maintained by the resource management circuitry/logic 208 of FIG. 2, the workload information circuitry/logic 216 of FIG. 2, the resource management circuitry/logic 424 of FIG. 4, and/or one or more other components as described herein.

The wireless link monitoring table 512 may include a “LINK ID” field that uniquely identifies each wireless connection, matching the identifiers used in the link allocation table of FIG. 5C. For example, the table shows wireless links “WL-1001”, “WL-1002”, “WL-1003”, and “WL-1004”. The “SOURCE NODE” and “DEST. NODE” fields identify the endpoints of each wireless link, such as “Server-A” to “Server-B” for link “WL-1001” and “Server-C” to “Server-D” for link “WL-1002”. These fields can provide spatial context for each connection within the data center topology.

The “FREQ. BAND” field specifies the frequency range utilized for each wireless link, such as “60 GHz” for link “WL-1001” and “28 GHz” for link “WL-1002”. These frequency selections may correspond to different wireless communication standards or custom implementations optimized for data center environments. The “CHANNEL WIDTH” field indicates the spectral bandwidth allocated to each link, expressed in megahertz (MHz). For example, link “WL-1001” utilizes a channel width of “2000 MHz”, while link “WL-1002” utilizes “800 MHz”. These allocations reflect the system's balancing of capacity requirements against spectrum availability.

The “MOD. SCHEME” field specifies the modulation technique employed for each wireless link, such as “64-QAM” for link “WL-1001” and “16-QAM” for link “WL-1002”. These modulation schemes determine how data is encoded onto the carrier signal and influence both data rate and signal robustness. The “TX PW” field indicates the transmission power level configured for each link, expressed in decibel-milliwatts (dBm). For example, link “WL-1001” operates at “18 dBm”, while link “WL-1003” operates at “20 dBm”. These power settings may be dynamically adjusted based on distance, interference levels, and required signal quality.

The “ANT BEAM ID” field identifies specific beamforming configurations used for directional transmission, such as “Beam-3” for link “WL-1001” and “Beam-1” for link “WL-1002”. These beamforming patterns focus wireless energy in specific directions to improve signal strength and reduce interference between links. The “LINK QUALITY (SNR)” field provides a real-time measurement of signal-to-noise ratio in decibels (dB), such as “35 dB” for link “WL-1001” and “29 dB” for link “WL-1002”. These measurements quantify the quality of each wireless connection and may trigger adaptive adjustments when values fall below acceptable thresholds.

The “CURRENT STATUS” field indicates the operational condition of each wireless link, such as “Active” for links “WL-1001” and “WL-1002”, “Standby” for link “WL-1003”, and “Degraded” for link “WL-1004”. This status information alerts the system to potential issues and may initiate remedial actions such as parameter adjustments, route changes, or link deactivation depending on the severity of the condition.

FIG. 5E depicts an example of a workload and performance requirement level mapping and a workflow that may allocate communication resources based on a performance requirement level based on such mapping, in accordance with aspects of the present disclosure. In some instances, the resource management circuitry/logic 208 (FIG. 2A) may implement a workflow to allocate communication resources between wired links and wireless links based on the performance requirements of a performance requirement level associated with a workload.

In some aspects, workload to performance requirement level table 514 (or other structure) may map each defined workload type (e.g., “Web API Calls”, “DB Replication”, “VM Backups”, “ML Training”, etc.) to a corresponding Performance Requirement Level (PRL) identifier (PRL₁-PRL₄). This association enables a device, such as the resource management circuitry/logic 208 of FIG. 2A for example, to look up an appropriate service tier for a given workload type without having to evaluate quantitative metrics in real-time. The mapping in table 514 may be populated during an initial configuration based on baseline profiling, historical analysis, or heuristic classification. The table 514 can also be dynamically updated over time as workload patterns evolve or as the system learns from operational feedback.

The PRL identifiers in table 514 may serve as a key into a level definition table 516 that specifies quantitative performance parameters for each service tier. In the example shown, the PRL₁ entry defines a maximum latency of 20 ms, a minimum bandwidth of 500 Gbps, and a priority setting of “Medium”. However, this parametric list is not exhaustive; additional metrics such as jitter tolerance, packet loss budget, or power constraints may be included to further refine the resource allocation process. By externalizing these specifications into a dedicated table, a device, such as the resource management circuitry/logic 208 of FIG. 2A for example, can easily adjust service levels without modifying core allocation logic.

As an example, a workload record 518 may be generated for a detected traffic flow, capturing details like a unique workload ID and the associated workload type. In some implementations, the workload record 518 may include additional details, such as but not limited to source/destination addresses, security context, and other relevant metadata. The record 518 may be used to identify a performance requirement level 520. In some implementations, the identification of the performance requirement level 520 may be performed by a device, such as the resource management circuitry/logic 208 of FIG. 2A, for example.

Based on the performance specifications retrieved from table 516, communication resources may be allocated between one or more of the wired links 522 and/or wireless links 524. For example, traffic requiring stringent latency or priority handling may be preferentially steered over deterministic wired paths, while flows with more relaxed demands may exploit the flexibility of wireless spectrum. In some cases, a hybrid allocation that combines both link types may be used to balance performance and efficiency. Such routing logic can be implemented as a stand-alone hardware block or as a software function within the resource allocation circuitry/logic 220.

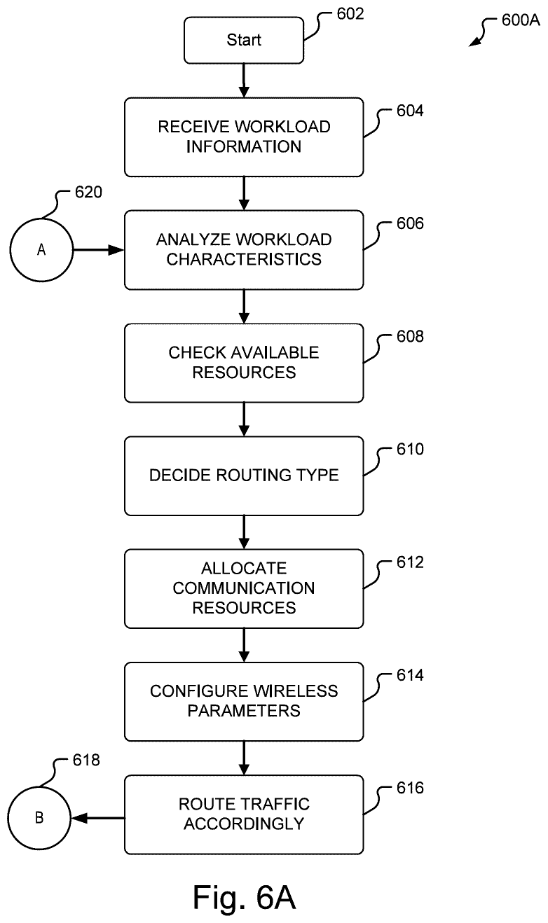

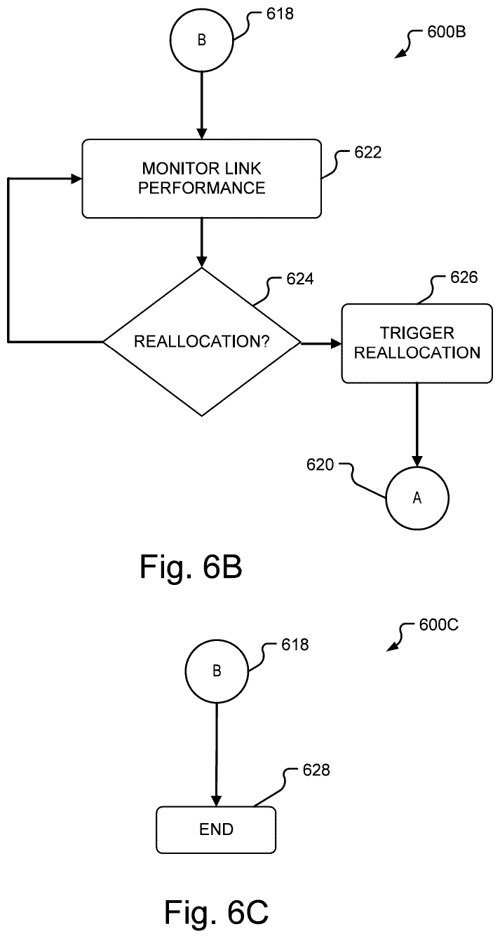

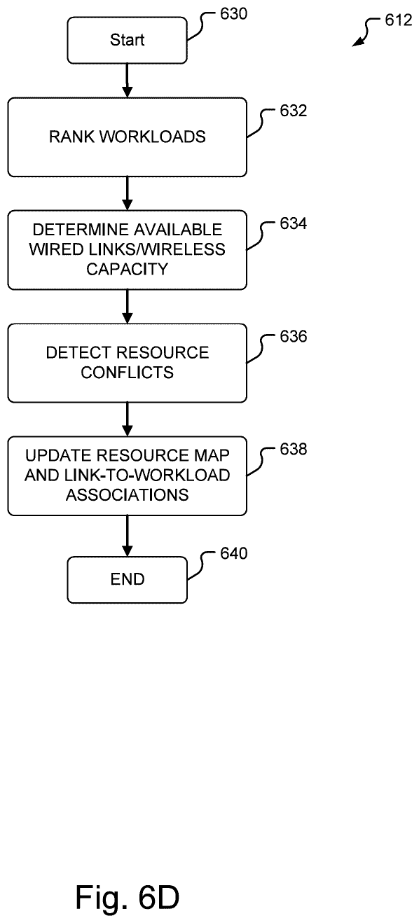

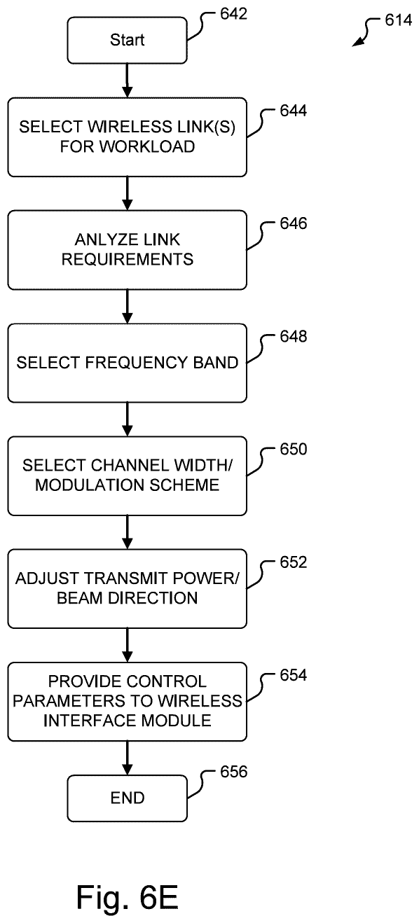

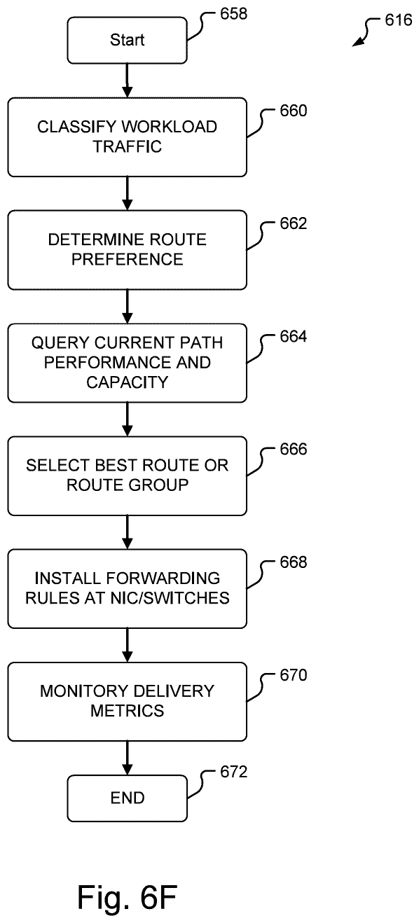

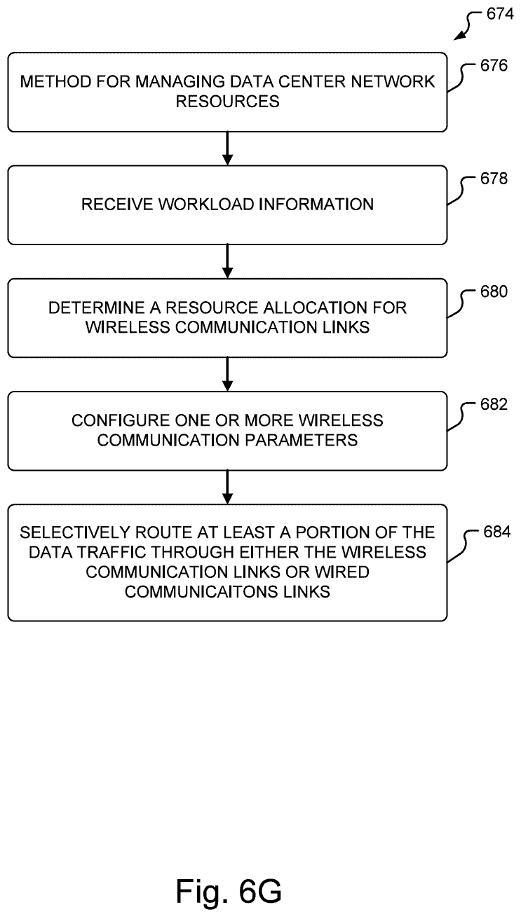

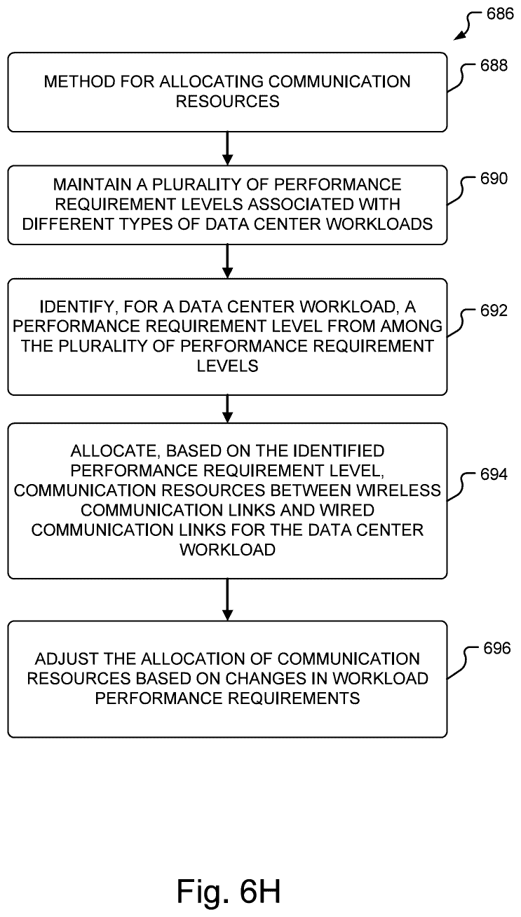

FIGS. 6A-6C illustrate a flowchart of a method 600 for dynamically allocating wireless and wired communication resources within a data center environment in accordance with at least some aspects of the present disclosure. The method 600 is divided into portions 600A, 600B, and 600C that collectively define a comprehensive resource management approach for adaptively configuring communication resources based on workload requirements and system conditions. The operations of method 600 may be performed by the resource management circuitry/logic 208 of FIG. 2A, the wireless interface 212, the routing circuitry/logic 214, and/or the resource management circuitry/logic 424 of FIG. 4.

FIG. 6A depicts a first portion 600A of the method 600 that begins at block 602, which designates the start of the dynamic resource allocation procedure. This initialization may be triggered by various events within the data center environment, such as the detection of new workloads, changes in traffic patterns, or scheduled resource optimization intervals. The start operation may include initializing relevant data structures, acquiring system locks or permissions, and preparing monitoring systems for subsequent operations. This initialization may be performed by the processing circuitry 420 of FIG. 4 in conjunction with instructions stored in memory 422.

At block 604, the method includes receiving workload information associated with data traffic in the data center. Portions of block 604 may refer to the input 204 and the workload information circuitry/logic 216 of FIG. 2A, which receive and process the workload information, respectively. Additionally, the workload classifier 242 of FIG. 2B may receive and initially categorizing the received information. The workload information may comprise a diverse set of parameters characterizing the computational and communication needs of applications, services, or processes operating within the data center environment. This information may be acquired through various channels, including but not limited to, application programming interfaces (APIs), telemetry systems, system management software, or direct monitoring of network traffic patterns. The workload information may include metadata such as application identifiers, process types, priority levels, and quality of service requirements. A system may gather temporal data including historical usage patterns, predicted resource requirements, and scheduled operations that might affect bandwidth demands or processing requirements. The information may also include spatial aspects such as the physical or logical locations of compute, storage, and networking resources involved in the workload execution. Based on the received workload information, a system can establish a baseline for making informed resource allocation decisions that align with the needs and characteristics of current and anticipated data center operations. The workload information may be structured similarly to the workload classification table 508 illustrated in FIG. 5B, where workload identifiers, source and destination nodes, traffic types, priority levels, and performance requirements are organized for subsequent analysis.

At block 606, the method proceeds to analyze workload characteristics to classify the nature and requirements of the data traffic. Portions of block 606 may be performed by the workload information circuitry/logic 216 of FIG. 2A in conjunction with the workload classifier 242 of FIG. 2B. The traffic classification block 262 of FIG. 2C may also be utilized to categorize incoming data flows according to predetermined classification criteria. This analysis may involve categorization of workloads based on their operational patterns, such as identifying compute-intensive, data-intensive, or latency-sensitive traffic. The analysis may implement pattern recognition techniques to identify traffic signatures associated with specific application types or operational phases. Machine learning models trained on historical workload data may be employed to predict resource requirements and classify incoming traffic according to established categories. Complex workloads may be decomposed into constituent components with distinct resource requirements, enabling granular resource allocation. The analysis may also involve temporal evaluation to identify cyclical patterns, trends, or anomalies in workload behavior that might influence resource allocation strategies. The QoS mapping table 258 from FIG. 2B may be consulted during this analysis to establish associations between workload requirements and appropriate service classes. The results of this analysis may be organized in a structure similar to the workload classification table 508 shown in FIG. 5B.

At block 608, the method includes checking available resources within the data center environment. Portions of this resource assessment operation may be performed by the resource inventory manager 246 of FIG. 2B, which maintains a comprehensive real-time view of communication resources available within the data center. The resource management circuitry/logic 208 of FIG. 2A may coordinate this assessment by gathering information from various components of the system. This resource assessment provides a real-time inventory of communication capacity that can be allocated to the analyzed workloads. The resource check may survey the status of wired connections, including port availability, link utilization, and quality metrics across physical cables, optical fibers, and associated hardware. For wireless resources, the check may examine available frequency bands, channel capacity, signal quality measurements, and the operational status of wireless transceivers and antenna systems. The ports 402a-402n (wired) and ports 404a-404n (wireless) of FIG. 4 may provide status information regarding their availability and current utilization. The resource assessment may include evaluation of both dedicated and shared resources, taking into account current allocation commitments and reservation policies. The check may also consider infrastructure constraints such as power limitations, thermal conditions, or physical distance between communication endpoints that might affect resource availability or performance. The information collected during the resource assessment may be organized in a structure similar to the link allocation table 510 shown in FIG. 5C, which tracks active communication resources.

Following the resource assessment, at block 610, the method 600A involves deciding a routing type for the workload traffic. This decision operation may be performed at least partially by the routing selector 248 of FIG. 2B in conjunction with the routing circuitry/logic 214 of FIG. 2A. The policy engine 244 of FIG. 2B may also be utilized to consult organizational guidelines and service-level agreements to influence the routing decisions. This decision process evaluates whether data should be transmitted via wired connections, wireless links, or a hybrid approach that leverages both communication media. The routing type decision may implement multi-criteria decision algorithms that weigh factors such as workload priority, latency requirements, bandwidth needs, and resource availability. The decision logic may consider reliability implications, evaluating the error characteristics and stability of different communication paths in the context of workload tolerance for transmission issues. Power efficiency considerations may influence routing decisions, particularly in environments where energy consumption is a significant operational factor. The system may also evaluate security requirements, as certain workloads may have specific transmission security needs that favor particular routing types. The priority queue block 264 of FIG. 2C may provide input to this decision process by indicating the priority levels assigned to different traffic flows. The “SUGGESTED ROUTE” field in the workload classification table 508 of FIG. 5B may reflect the outcome of this routing type decision, indicating preferred communication media for different workloads. Through this comprehensive decision process, the system determines the most appropriate communication pathway for each workload based on its specific characteristics and requirements.

At block 612, the method proceeds to allocate communication resources according to the routing decision and workload requirements. This allocation operation may be performed by the resource allocation circuitry/logic 220 of FIG. 2A, working in coordination with the wired link allocator 252 and wireless link allocator 254 of FIG. 2B. In an example involving switching hardware 410 of FIG. 4, the switching hardware 410 of FIG. 4 may implement the actual hardware-level allocation by directing data flows to appropriate ports. This allocation process of block 612 may assign specific communication pathways, bandwidth capacity, and quality of service parameters to support the workload execution. For wired resources, allocation may involve port assignments, virtual circuit establishment, or bandwidth reservations across physical connections using ports 402a-402n of FIG. 4. With wireless resources, allocation may include frequency band assignment, transmission time slots, or spatial divisions through beamforming configurations using ports 404a-404n of FIG. 4. The allocation process may implement fairness mechanisms to balance resources across competing workloads according to their relative priorities and requirements. Resource allocation may include both immediate provisions for current needs and reservations for anticipated future requirements based on workload projections. The allocation may establish resource boundaries through mechanisms such as rate limiting, traffic shaping, or priority queuing to ensure workloads operate within their assigned resource constraints. The link allocation table 510 of FIG. 5C may be updated to reflect the new allocation decisions, tracking which workloads are assigned to which communication links. Through this detailed allocation process, the system assigns appropriate communication capacity to each workload based on its requirements and the available resource inventory.

When wireless routing is selected, the method continues at block 614 with configuring wireless parameters to optimize the wireless communication links. This configuration operation may be performed by the wireless tuning logic 250 of FIG. 2B, which translates high-level resource allocation decisions into specific technical configurations for wireless links. The wireless communication parameters 210 of FIG. 2A may be generated during this step to configure operational parameters for wireless links. The wireless interface 212 of FIG. 2A would then implement these configurations at the hardware level. This configuration process adapts the physical and logical characteristics of wireless transmissions to meet workload requirements while maximizing efficiency and reliability. Parameter configuration may adjust frequency assignments to select optimal bands based on distance, interference patterns, and bandwidth requirements. Modulation schemes may be configured to balance data rate against transmission robustness, adapting to signal conditions and error tolerance requirements. Power settings may be adjusted to maintain signal integrity while minimizing energy consumption and potential interference with other wireless links. Beamforming configurations may be established to direct wireless energy precisely toward intended receivers, enhancing signal strength while reducing spillover into adjacent areas. Coding schemes may be selected to provide appropriate error detection and correction capabilities based on channel conditions and reliability requirements. Medium access parameters may be configured to control transmission timing and channel sharing among multiple wireless links. The wireless link monitoring table 512 of FIG. 5D may be updated to reflect the configured parameters, including frequency band, channel width, modulation scheme, transmission power, and antenna beam IDs.

At block 616, the method executes the actual routing of traffic according to the decisions and configurations established in previous steps. This routing implementation may be performed by the routing circuitry/logic 214 of FIG. 2A in conjunction with the switching hardware 410 of FIG. 4. For traffic prioritization, the priority queue block 264 of FIG. 2C may direct traffic to either the wired interface 266 or wireless interface 268 based on priority levels. This routing implementation directs data flows through the allocated communication paths, applying the specified parameters and policies to the actual transmission of information. The routing execution may involve programming switches, routers, or software-defined networking controllers to establish flow rules that direct packets along designated paths. Quality of service mechanisms may be activated to enforce prioritization, bandwidth guarantees, or latency constraints according to the workload requirements. Traffic shaping or rate limiting functions may be engaged to maintain compliance with allocation boundaries and prevent resource oversubscription. The queues 412a-412n for wired ports and queues 416a-416n for wireless ports in FIG. 4 may be configured during this stage to support appropriate buffering and prioritization. The system may establish monitoring hooks to track the performance of routed traffic for subsequent evaluation. The configurations in diagrams 502 and 504 of FIG. 5A represent examples of network topologies that might result from this routing implementation, where connections may include both wired and wireless links arranged to support workload requirements.

Following the initial routing implementation, the method proceeds to node B 618, which serves as a connection point to the monitoring and adaptation logic illustrated in FIG. 6B. The method also references node A 620, which serves as an entry point for reallocation processes triggered by changing conditions or requirements.

FIG. 6B illustrates a second portion 600B of the method 600, focusing on performance monitoring and adaptive reallocation of communication resources. This portion begins from node B 618, which connects from the initial resource allocation and routing implementation illustrated in FIG. 6A.

At block 622, the method involves monitoring link performance across the established communication paths. This monitoring operation may be performed by the feedback integrator 260 of FIG. 2B, which processes performance measurements and operational metrics from the data center environment. The processing circuitry 420 of FIG. 4 may collect telemetry data from various components of the interconnect device to support this monitoring. This monitoring process continuously evaluates the operational characteristics and efficiency of both wired and wireless links to identify potential issues or optimization opportunities. The performance monitoring may track throughput metrics, measuring the actual data transfer rates achieved compared to allocated capacity. Latency measurements may assess transmission delays across communication paths, identifying variations or trends that might affect application performance. Reliability metrics such as packet loss rates, bit error rates, or retransmission statistics may be collected to evaluate connection stability. For wireless links specifically, signal quality indicators such as signal-to-noise ratio, received signal strength, or interference levels may be monitored to assess transmission conditions. The “LINK QUALITY (SNR)” field in the wireless link monitoring table 512 of FIG. 5D may be updated during this monitoring process to reflect current performance measurements. Resource utilization tracking may identify periods of underutilization or congestion that might warrant reallocation. The monitoring may implement various sampling techniques, including periodic polling, event-triggered measurements, or continuous stream analysis, to balance monitoring precision against system overhead.

At decision block 624, the method evaluates whether reallocation of communication resources is needed based on the monitored performance and changing conditions. This evaluation operation may be performed by the reallocation trigger logic 256 of FIG. 2B, which assesses whether current resource allocations remain optimal given changing conditions. The resource management circuitry/logic 208 of FIG. 2A may coordinate this decision process by integrating information from multiple system components. This decision process analyzes performance metrics and contextual information to determine if the current resource allocation remains optimal or requires adjustment. The reallocation decision may consider performance threshold violations, such as when latency, throughput, or error rates cross predefined boundaries that indicate suboptimal operation. Trend analysis may identify gradual degradation or improvement in communication performance that suggests changing conditions requiring resource adjustment. Workload changes, such as the arrival of new applications, completion of existing processes, or shifts in computational patterns, may trigger reallocation needs. Resource competition evaluation may identify contention scenarios where multiple workloads are competing for limited communication capacity, necessitating reprioritization or rebalancing. The “CURRENT STATUS” field in the wireless link monitoring table 512 of FIG. 5D may influence this decision, particularly when links are marked as “Degraded” or experiencing performance issues. External factors such as maintenance events, hardware failures, or environmental changes affecting signal propagation may also influence reallocation decisions. If the evaluation determines that reallocation is not required, the method loops back to continue performance monitoring at block 622, maintaining the current resource configuration.

If reallocation is needed, the method proceeds to block 626, where it triggers the reallocation process to adapt communication resources to changing conditions or requirements. This triggering operation may be performed by the reallocation trigger logic 256 of FIG. 2B in conjunction with the resource allocation circuitry/logic 220 of FIG. 2A. The wireless link allocator 254 and wired link allocator 252 of FIG. 2B may implement specific reallocation actions for their respective communication types. This triggering action initiates the systematic reconfiguration of resource assignments to optimize performance based on current system state. The reallocation trigger may initiate different types of adjustments depending on the identified issues or opportunities. Configuration changes may modify wireless parameters such as frequency, power, or modulation to improve link quality without changing the overall allocation structure. Routing adjustments may redirect traffic through alternative paths to alleviate congestion or bypass degraded links. Capacity rebalancing may reallocate bandwidth or airtime across workloads based on changing priorities or requirements. The establishment of the connection 506 (e.g., wireless link) in diagram 504 of FIG. 5A illustrates how reallocation might activate additional wireless connections in response to changing workload demands. The reallocation trigger may implement escalation mechanisms, where progressive adjustments are attempted before more disruptive changes are considered. Coordination mechanisms may ensure that reallocation actions across different parts of the system are synchronized to prevent conflicts or cascading issues. The link allocation table 510 of FIG. 5C and wireless link monitoring table 512 of FIG. 5D would be updated to reflect the reallocation decisions, including updated status of links, new workload assignments, and modified wireless parameters. Following the reallocation trigger, the method returns to node A 620, which reconnects to the workload analysis and resource allocation logic in FIG. 6A, enabling a comprehensive reassessment and adjustment of the communication resources.

FIG. 6C illustrates a third portion 600C of the method 600, showing the completion path for the resource management process. From node B 618, which follows the initial routing implementation or continues from the monitoring loop when no reallocation is required, the method may proceed to block 628, which represents the end of a resource management cycle. This termination operation may be performed by the resource management circuitry/logic 208 of FIG. 2A or the processing circuitry 420 of FIG. 4, which coordinate the orderly completion of the resource management activities. This termination point may be reached under various conditions, such as the completion of a scheduled optimization interval, successful execution of all workloads, or system shutdown procedures. The end operation may include actions such as releasing temporary resources, updating system logs with allocation decisions and performance metrics, or notifying management systems about the completed cycle. The resource inventory manager 246 of FIG. 2B may update its records to reflect the final state of communication resources at the conclusion of the management cycle. Link status information in tables such as the link allocation table 510 of FIG. 5C may be finalized to document the operational state at cycle completion.

FIG. 6D illustrates a flowchart of a method 612 for allocating communication resources within a data center environment in accordance with at least some aspects of the present disclosure. The method 612 provides an expanded view of the resource allocation operation referenced in block 612 of FIG. 6A, providing additional information with respect to assigning wired and wireless communication resources based on workload priorities and system conditions.

The method 612 begins at start block 630, which initializes the resource allocation procedure. This initialization may include preparing data structures for tracking resource assignments, accessing policy configurations, and establishing connectivity with resource management components within the data center infrastructure.

At block 632, the method proceeds to rank workloads according to their relative importance, performance requirements, and operational characteristics. This ranking operation may be performed by the resource allocation circuitry/logic 220 of FIG. 2A in conjunction with the policy engine 244 of FIG. 2B. The workload ranking process may establish an order that determines which workloads receive priority when allocating limited communication resources. Ranking factors may include application criticality, business impact, latency sensitivity, throughput requirements, and quality of service classifications. The ranking mechanism may implement various prioritization algorithms such as weighted scoring, multi-criteria analysis, or policy-driven classification to generate a hierarchical ordering of workloads. This ordered list provides for subsequent resource allocation decisions such that high-priority workloads receive appropriate resources even under constrained conditions. The workload rankings may be reflected in data structures similar to the workload classification table 508 of FIG. 5B, where priority levels are explicitly recorded.

At block 634, the method 612 determines available wired links and wireless capacity within the data center environment. This resource assessment operation may be performed by the resource inventory manager 246 of FIG. 2B, which may maintain information of communication resources. In a non-limiting example utilizing the interconnect device 302 of FIG. 4, ports 402a-402n (wired) and ports 404a-404n (wireless) of FIG. 4 may be queried to determine their current operational status and available capacity. The determination process may create an inventory (e.g., in real-time) of connectivity options that can be allocated to ranked workloads. For wired resources, the assessment identifies available physical ports, link speeds, current utilization levels, and quality metrics across cabled connections. For wireless resources, the assessment examines available frequency bands, channel capacity, spatial degrees of freedom through beamforming, and the operational status of transceivers and antenna systems. The resource assessment may also consider infrastructure constraints such as power limitations, thermal conditions, or physical distance between endpoints that might affect resource performance. The resulting inventory provides a comprehensive view of allocatable resources that serves as input for subsequent allocation decisions.

At block 636, the method 612 may detect resource conflicts that may arise when multiple workloads compete for limited communication capacity. This conflict detection may be performed by the resource allocation circuitry/logic 220 of FIG. 2A, working in conjunction with the wired link allocator 252 and wireless link allocator 254 of FIG. 2B. The conflict detection process identifies scenarios where workload demands exceed available capacity or where incompatible requirements create allocation challenges. The detection may identify oversubscription conditions where aggregated bandwidth requests exceed link capacity. Spatial conflicts may be detected when multiple wireless links attempt to use the same physical space or frequency channel in ways that would create interference. Temporal conflicts may arise when workloads with different timing requirements attempt to share resources without compatible scheduling. Priority inversions, where lower-priority workloads might block resources needed by higher-priority workloads, can also be identified during this stage. By systematically identifying these potential resource conflicts, the system can apply appropriate resolution strategies in subsequent allocation stages.

At block 638, the method 612 updates the resource map and link-to-workload associations based on allocation decisions. This update operation may be performed by the resource allocation circuitry/logic 220 of FIG. 2A in coordination with the wired link allocator 252 and wireless link allocator 254 of FIG. 2B. The update process formalizes the resource allocation by recording associations between specific workloads and their assigned communication paths in system-wide data structures. The update may modify routing tables, flow rules, or connection matrices that control how data is directed through the network infrastructure. Configuration parameters for wireless and wired interfaces may be updated to reflect new resource assignments. Reservation records may be established to ensure allocated resources remain available for their assigned workloads until explicitly released. The link allocation table 510 of FIG. 5C may be updated during this process to reflect the new workload assignments and resource configurations. The resource map update may provide a record of allocation decisions, providing a reference point for subsequent routing, monitoring, and reallocation activities.

The method 612 concludes at end block 640, completing the resource allocation process. The allocation decisions and resource assignments established during this method may then be used by subsequent operations such as wireless parameter configuration (block 614 of FIG. 6A) and traffic routing (block 616 of FIG. 6A) to implement the determined resource allocation within the physical infrastructure.

FIG. 6E illustrates a flowchart of a method 614 for configuring wireless parameters within a data center environment in accordance with at least some aspects of the present disclosure. The method 614 provides additional details of the wireless parameter configuration referenced in block 614 of FIG. 6A, to optimize wireless links and support allocated workloads.

The method 614 begins at start block 642, which may initialize a wireless configuration procedure. This initialization may include accessing resource allocation decisions, retrieving workload specifications, and establishing connections to wireless interface control systems.

At block 644, the method 614 selects wireless links for the targeted workload based on allocation decisions previously made. This selection operation may be performed by the wireless link allocator 254 of FIG. 2B in conjunction with the resource allocation circuitry/logic 220 of FIG. 2A. The link selection process identifies specific wireless connections to be established or modified to support the workload requirements. The selection may consider factors such as physical proximity between endpoints, potential signal paths, existing link utilization, and compatibility with workload characteristics. For systems with multiple wireless technologies, the selection may determine the most appropriate communication standard or protocol based on distance, bandwidth requirements, and reliability expectations. The link selection may establish point-to-point connections for dedicated workloads or shared links for multiple traffic flows with compatible requirements.

At block 646, the method analyzes link requirements based on workload characteristics and operational context. This analysis operation may be performed by the wireless tuning logic 250 of FIG. 2B, which may translate high-level resource allocation decisions into specific technical configurations. The link analysis process may examine the performance needs and constraints associated with the selected wireless links to inform parameter decisions. The analysis may evaluate bandwidth requirements derived from expected data volumes and transmission patterns. Latency constraints may be assessed based on application timing requirements and sensitivity to transmission delays. Reliability needs may be determined from workload error tolerance and criticality classifications. Environmental factors such as distance between endpoints, potential obstacles, or sources of interference may be considered when evaluating link challenges. The analysis may also incorporate historical performance data from similar configurations to anticipate potential issues or optimization opportunities.

At block 648, the method 614 may select an appropriate frequency band for the wireless link based on requirements analysis. This selection operation may be performed by the wireless tuning logic 250 of FIG. 2B in coordination with the wireless interface 212 of FIG. 2A. The frequency selection process can determine the spectral region that will carry the wireless transmissions, balancing factors such as range, capacity, and interference. Available frequency options may include millimeter wave bands (such as 28 GHz, 60 GHz, or 73 GHz) for high-bandwidth, short-range connections, or lower frequency bands for connections requiring greater range or obstacle penetration. The selection may consider current spectrum utilization within the data center to avoid congestion or interference with existing wireless links. Regulatory constraints and licensed or unlicensed band availability may influence which frequency options can be considered. The distance between communication endpoints may affect frequency selection, as higher frequencies typically provide greater bandwidth but with more limited range.

At block 650, the method 614 may select channel width and modulation scheme parameters to optimize the wireless link performance. This selection operation may be performed by the wireless tuning logic 250 of FIG. 2B based on the requirements analysis and frequency selection from previous steps. The channel width and modulation selection process can define how data will be encoded onto the carrier signal and how much spectral resources will be utilized for the link. Channel width decisions may allocate larger portions of spectrum (e.g., 2000 MHz) for high-bandwidth applications or narrower channels (e.g., 500 MHz) for links where spectral efficiency is prioritized over raw throughput. Modulation scheme selection may range from simple, robust schemes like QPSK for challenging environments to complex, high-order schemes like 64-QAM or 256-QAM for links requiring maximum data rates under favorable conditions. The selection may implement adaptive modulation capabilities that can dynamically adjust encoding based on measured signal quality. Trade-offs between data rate and error resilience may be evaluated based on workload priorities and reliability requirements. The “MOD. SCHEME” field in the wireless link monitoring table 512 of FIG. 5D could be updated to reflect these configuration decisions.

At block 652, the method 614 may adjust transmit power and beam direction to optimize signal quality and minimize interference. This adjustment operation may be performed by the wireless tuning logic 250 of FIG. 2B in conjunction with the wireless interface 212 of FIG. 2A. The power and beamforming adjustment process may configure the spatial characteristics of the wireless transmission to enhance link performance. Transmit power levels may be set based on link distance, required signal-to-noise ratio, and energy efficiency considerations. Higher power settings may be configured for longer links or challenging environments, while reduced power may be used for shorter links to minimize interference and energy consumption. Beamforming directionality may be adjusted using phased array antennas or directional elements to focus transmission energy toward intended receivers while minimizing signal leakage to other areas. The beam patterns may be shaped to accommodate physical layout constraints or to create spatial multiplexing opportunities where multiple non-interfering beams can operate in the same frequency band. These adjustments may be recorded in the “TX PW” and “ANT BEAM ID” fields of the wireless link monitoring table 512 of FIG. 5D, documenting the specific configuration for each link.

At block 654, the method 614 provides control parameters to the wireless interface module to implement the configured settings. This provision operation may be performed by the wireless tuning logic 250 of FIG. 2B, which generates specific control signals for the wireless interface 212 of FIG. 2A. The parameter provision process translates high-level configuration decisions into specific hardware control signals that can be applied to physical wireless transceivers and antenna systems. The control parameters may include register settings for radio frequency components such as oscillators, amplifiers, and filters that establish the selected frequency and power characteristics. Digital signal processing configurations may define modulation mappings, symbol rates, error correction coding, and other baseband processing aspects. Medium access control parameters may specify timing relationships, transmission scheduling, or contention handling mechanisms. Antenna control signals may configure phasing relationships, gain settings, or switching patterns to implement the desired beamforming characteristics.

The method 614 concludes at end block 656, completing the wireless parameter configuration process. The configured wireless links, supporting the designated workloads according to their specific requirements, with settings for one or more of frequency, modulation, power, and directionality, may provide the communication channels through which data traffic will be routed in subsequent operational stages.

FIG. 6F illustrates a flowchart of a method 616 for routing traffic within a data center environment in accordance with at least some aspects of the present disclosure. The method 616 provides additional details of the traffic routing operation referenced in block 616 of FIG. 6A.

The method 616 begins at start block 658, which may initialize a traffic routing procedure. This initialization may include accessing resource allocation records, preparing routing subsystems, and establishing connectivity with network control components. At block 660, the method 616 may classify workload traffic to determine appropriate handling requirements. This classification operation may be performed by the traffic classification block 262 of FIG. 2C, which analyzes incoming data flows to categorize them according to predetermined criteria. The workload classifier 242 of FIG. 2B may also contribute to this classification process. The traffic classification process examines packet streams, flow patterns, or application markers to identify the nature and requirements of different data flows within the data center. The classification may employ deep packet inspection to analyze header fields, payload characteristics, or protocol patterns that indicate specific application types or traffic classes. Flow analysis may identify temporal patterns, packet size distributions, or inter-arrival timing that suggests particular workload categories. Application fingerprinting may correlate traffic patterns with known signatures of specific applications or services. The classification may implement machine learning models trained on historical data to recognize and categorize new traffic patterns based on established models.

At block 662, the method 616 may determine route preferences based on workload classifications and system policies. This determination operation may be performed by the routing selector 248 of FIG. 2B in conjunction with the routing circuitry/logic 214 of FIG. 2A. The policy engine 244 of FIG. 2B may provide input regarding organizational priorities and service-level agreements. The route preference determination process evaluates which communication paths are most appropriate for each classified data flow, considering factors such as performance requirements, resource availability, and operational policies. The determination may consider latency sensitivity, selecting low-latency paths such as direct wired connections for time-critical applications while allowing indirect or wireless routes for delay-tolerant traffic. Bandwidth requirements may influence path selection, directing high-volume flows through high-capacity links while routing lower-bandwidth traffic through alternative paths. Reliability considerations may lead to selection of paths with lower error rates or built-in redundancy for critical workloads. Security policies may restrict certain traffic types to specific network segments or transmission media based on data sensitivity or compliance requirements. The route preference determination creates a mapping between each classified data flow and its optimal communication path through the data center infrastructure.

At block 664, the method 616 may assess the real-time state of potential routes by querying current path performance and capacity. This query operation may interact with network monitoring systems, telemetry collection services, or direct device interfaces to gather current operational metrics. The path assessment process evaluates the actual performance characteristics and available capacity of communication paths being considered for traffic routing. The assessment may measure current throughput metrics such as bandwidth utilization, packet rates, or bytes transferred across potential paths to identify congestion or available capacity. Latency measurements may evaluate current transmission delays, jitter, or timing variations that could affect application performance. Reliability metrics such as bit error rates, packet loss statistics, or retransmission counts may be assessed to evaluate path stability. For wireless paths specifically, signal quality indicators such as signal-to-noise ratio, received signal strength, or interference levels may be queried to evaluate current transmission conditions.

At block 666, the method 616 selects the best route or route group based on preferences and current conditions. This selection operation may be performed by the routing selector 248 of FIG. 2B in coordination with the routing circuitry/logic 214 of FIG. 2A. The route selection process determines the specific communication path or paths through which data will be transmitted, integrating both predetermined preferences and real-time network state. The selection may implement priority-based routing algorithms that select optimal paths for high-priority traffic first, followed by best-available paths for lower-priority flows. Adaptive techniques may dynamically select routes based on current network conditions, avoiding congested paths even if they would normally be preferred. Multi-path approaches may distribute traffic across multiple routes to increase aggregate bandwidth or provide redundancy for critical flows. Cost-based selection may evaluate multiple factors such as latency, available bandwidth, and reliability as weighted components of a composite routing metric. Dynamic adjustments to selection criteria may occur based on time of day, current workload mix, or operational status. By integrating route preferences with current network state, the selection process determines the optimal communication path for each data flow based on both static requirements and dynamic conditions.

At block 668, the method 616 installs forwarding rules at network interface controller s and switches to implement the selected routes. As a non-limiting example, this installation operation may interact with the switching hardware 410 of FIG. 4, programming its forwarding tables or match-action entries to direct traffic appropriately. The rule installation process configures the network infrastructure to direct data packets along the selected communication paths through the data center. The installation may program flow table entries for software-defined networking controllers, defining match conditions and corresponding actions for handling specific traffic types. Hardware-based forwarding rules may be configured in switching ASICs or network processors, establishing line-rate packet processing pipelines that direct traffic without software intervention. Quality of service directives may be installed to implement traffic shaping, bandwidth reservation, or prioritization mechanisms that enforce performance guarantees. Access control policies may be deployed alongside forwarding rules to ensure proper segmentation and security enforcement. The queues 412a-412n for wired ports and queues 416a-416n for wireless ports in FIG. 4 may be configured during this stage to support appropriate buffering and prioritization according to traffic classifications. By installing these forwarding rules throughout the network fabric, the system creates a consistent, end-to-end path for each data flow that aligns with its routing requirements.

At block 670, the method 616 may monitor delivery metrics to evaluate routing effectiveness and detect performance issues. This monitoring operation may be performed by the feedback integrator 260 of FIG. 2B, which processes performance measurements from the data center environment. The delivery monitoring process continuously evaluates the operational performance of established routes to identify potential issues or optimization opportunities. The monitoring may track throughput metrics such as achieved bandwidth, goodput, or transfer completion times compared to expected values. Latency measurements may assess actual end-to-end delay, inter-packet gaps, or timing variations experienced by different traffic flows. Reliability metrics such as packet loss rates, checksum failures, or application-level retransmissions may be collected to evaluate connection stability. The monitoring may implement various measurement techniques including active probing, passive observation, or application-level instrumentation to gather comprehensive performance data. Threshold-based alerts may be configured to identify when delivery metrics deviate significantly from expected values or service-level targets. The monitoring results feed into the reallocation trigger logic 256 of FIG. 2B, potentially initiating the reallocation process depicted in FIG. 6B when performance issues are detected.

The method 616 concludes at block 672. The established routes may direct data flows through the data center network according to their requirements and classifications, leveraging both wired and wireless communication paths as appropriate based on workload characteristics and system conditions.

FIG. 6G depicts a method 672 for managing data center network resources in accordance with at least one aspect of the present disclosure, at least some concepts of which have been discussed with reference to FIG. 1-6F. In one aspect, method 672 can be implemented in one or more circuits, by resource management circuitry/logic 208 of FIG. 2, the interconnect device 302 of FIG. 4, the resource management circuitry/logic 424 of FIG. 4, and/or the processing circuitry 420 of FIG. 4. Of course the method 672 may be performed by one or more other devices of a network fabric as previously described herein. In some examples, the one or more circuits comprise hardware (e.g., processing circuitry, logic, queues, memory) or a combination of hardware and software that implement a dynamic allocation of wireless and wired communication resources within data center environments management functions described herein. As may be appreciated, the one or more circuits may be included in the resource management circuitry/logic 208, the interconnect device 302 of FIG. 4, and/or correspond to or involve elements 216, 220, 410, 418, 420, 422, and/or 424.

Method 672 may begin at block 676 and then flow to block 678 with receiving workload information associated with data traffic in a data center. In some aspects, block 678 may be performed as input 204 of FIG. 2A, which represents a communication interface for workload-related information, network telemetry data, and operational parameters. The workload information circuitry/logic 216 of FIG. 2A may process this incoming data to identify workload characteristics. In hardware implementations, this step may utilize communication interfaces within the processing circuitry 420 of FIG. 4 to acquire data from various monitoring systems throughout the data center. The workload classifier 242 of FIG. 2B may also be engaged during this operation to begin categorizing the incoming workload information for subsequent analysis.

Method 672 may then proceed to block 680 with determining, based on the workload information, a resource allocation for wireless communication links between computing devices in the data center. In some aspects, one or more portions of block 680 may be performed by the resource allocation circuitry/logic 220 of FIG. 2A in conjunction with the resource management circuitry/logic 208. The resource inventory manager 246 and routing selector 248 of FIG. 2B may contribute to this determination by providing information about available resources and optimal routing strategies. In a hardware implementation, this operation may utilize allocation algorithms implemented within the processing circuitry 420 of FIG. 4 for example, leveraging decision logic circuits or software executing on embedded processors. The determination process evaluates the analyzed workload information to identify appropriate wireless resource assignments that will meet performance requirements while optimizing overall system efficiency.

Method 672 may then proceed to block 682 with configuring one or more wireless communication parameters for the wireless communication links based on the determined resource allocation. This configuration operation may be performed by the wireless tuning logic 250 of FIG. 2B, which may translate high-level resource allocation decisions into specific technical configurations. The wireless communication parameters 210 of FIG. 2A may be generated during this step to provide operational settings to physical wireless hardware. In some aspects, at least some portions of block 682 may involve programming registers or control interfaces within the wireless interface 212 of FIG. 2A or the ports 404a-404n (wireless) of FIG. 4 for example. The configuration may adjust physical layer parameters such as frequency assignments, modulation schemes, power levels, or beamforming weights to optimize wireless link performance for the specific workload requirements identified in previous steps.

Method 672 may then end at block 684 with selectively routing at least a portion of the data traffic through either the wireless communication links or wired communication links based on the workload information. This routing operation may be performed by the routing circuitry/logic 214 of FIG. 2A in conjunction with the switching hardware 410 of FIG. 4 as an example. The traffic classification block 262 and priority queue block 264 of FIG. 2C may influence this routing by categorizing traffic and assigning appropriate priority levels. For traffic directed to wireless paths, the wireless interface 212 of FIG. 2A or ports 404a-404n of FIG. 4 may handle the transmission. For traffic routed to wired connections, the ports 402a-402n of FIG. 4 may manage the communication. Such routing may involve programming flow tables within network switches, configuring packet classification rules, or updating forwarding databases to ensure data flows are directed through appropriate communication paths based on their requirements and the available resources.

In some aspects of method 672, the workload information comprises at least one of: processing requirements; bandwidth requirements; latency requirements; or quality of service requirements.

In some aspects of method 672, the one or more wireless communication parameters comprise at least one of: frequency allocation; bandwidth allocation; modulation scheme; or transmission power.

In some aspects of method 672, the one or more circuits are further to: monitor performance metrics of the wireless communication links; and modify the resource allocation based on the monitored performance metrics.

In some aspects of method 672, the performance metrics comprise at least one of: throughput; latency; packet loss; or signal strength.

In some aspects of method 672, to selectively route at least a portion of the data traffic, the one or more circuits are further to route traffic of a first priority type through the wired communication links and traffic of a second priority type through the wireless communication links.

In some aspects of method 672, the one or more circuits are further to prioritize traffic of the second priority type by allocating additional wireless resources to communication links carrying the traffic of the second priority type.

In some aspects of method 672, the one or more circuits are further to identify the traffic of the second priority type based on at least one of: traffic type; source application; destination application; or quality of service requirements.

In some aspects of method 672, the computing devices comprise at least one of: a server; a storage device; a network interface controller; or a network switch.

In some aspects of method 672, the one or more circuits are further to adjust the resource allocation in response to changes in the workload information.

In some aspects of method 672, to dynamically adjust the resource allocation, the one or more circuits are further to reallocate wireless resources from first communication links to second communication links based on changes in workload priorities.

In some aspects of method 672, the one or more circuits are further to: maintain a mapping between wireless resources and data center workloads; and update the mapping based on changes in the workload information.

In some aspects of method 672, to update the mapping, the one or more circuits are further to reassign wireless resources based on at least one of: workload priority changes; network congestion; or performance requirements.

Method 672 provides technical benefits to data center operations by enabling dynamic and automated management of hybrid wired-wireless network infrastructure. This approach improves resource utilization efficiency by allocating communication resources based on real-time workload demands rather than static provisioning, thereby reducing overprovisioning and associated costs. The method enables rapid reconfiguration of network topology without physical cable changes, substantially reducing maintenance downtime and operational complexity. By selectively routing traffic through either wired or wireless paths based on traffic priority and performance requirements, the system maintains optimal performance for critical applications while maximizing overall throughput. The adaptive nature of the method also enhances scalability, allowing data centers to expand capacity incrementally without comprehensive infrastructure overhauls, and improves resilience by providing alternative communication paths during component failures or maintenance activities.

Traditional data center networks face a fundamental technical problem: the inherent inflexibility of fixed wired infrastructure creates significant challenges in adapting to fluctuating workload demands, resulting in either resource underutilization during normal operations or performance bottlenecks during peak loads. Physical cabling constraints limit reconfiguration capabilities, requiring extensive planning, installation time, and potential service disruptions when network changes are needed to accommodate evolving application requirements. Method 672 provides at least one solution to this technical problem by implementing a hybrid communication approach that dynamically integrates wireless links alongside traditional wired connections. The method 672 may analyze workload characteristics and network conditions to determine optimal resource allocation, configures wireless parameters to establish performance-appropriate wireless links, and intelligently routes traffic through either medium based on priority and performance requirements. This solution may transform the static physical network topology into a flexible, software-defined communication fabric that can adapt in real-time to changing demands without physical reconfiguration, thereby eliminating the technical constraints of traditional infrastructure while maintaining deterministic performance for critical applications.

FIG. 6H depicts a method 686 for allocating communication resources in accordance with at least one aspect of the present disclosure, at least some concepts of which have been discussed with reference to FIG. 1-6G. In one aspect, method 686 can be implemented in one or more circuits, by resource management circuitry/logic 208 of FIG. 2, the interconnect device 302 of FIG. 4, the resource management circuitry/logic 424 of FIG. 4, and/or the processing circuitry 420 of FIG. 4. Of course the method 686 may be performed by one or more other devices of a network fabric as previously described herein. In some examples, the one or more circuits comprise hardware (e.g., processing circuitry, logic, queues, memory) or a combination of hardware and software that implement a dynamic allocation of wireless and wired communication resources within data center environments management functions described herein. As may be appreciated, the one or more circuits may be included in the resource management circuitry/logic 208, the interconnect device 302 of FIG. 4, and/or correspond to or involve elements 216, 220, 410, 418, 420, 422, and/or 424.

Method 686 may begin at block 688 and then flow to block 690 with maintaining a plurality of performance requirement levels associated with different types of data center workloads. For example, a plurality of performance requirement levels associated with different types of data center workloads may be maintained. This may involve defining a set of service tiers, each with specific performance characteristics, and mapping those tiers to the various classes of traffic expected in the data center environment. The mapping may be represented as a lookup table or other suitable data structure that enables quick translation from a workload type to its corresponding requirement level. The performance levels encapsulate metrics such as maximum latency, minimum bandwidth, priority classification, and other relevant parameters that guide resource allocation decisions. By separating the workload and performance requirement levels from performance requirement level parameter definitions, a system can adjust service levels and accommodate new workload types without modifying core allocation logic.

Method 686 may then proceed to block 692 with identifying, for a data center workload, a performance requirement level from among the plurality of performance requirement levels. In block 692, the method identifies the specific PRL for the current data center workload being processed. This may involve generating a workload record 518 that captures the unique workload ID and workload type. The workload type may then be used as a key to look up the corresponding PRL identifier (e.g. PRL₁) from the workload-to-level association table 514 maintained in block 690. The PRL selection can be implemented using various techniques such as a content-addressable memory, associative array, or hash table lookup. The result of this operation is the specific PRL (service tier) that should be applied when allocating network resources to the workload.

Method 686 may then proceed to block 694 with allocating, based on the identified performance requirement level, communication resources between wireless communication links and wired communication links for the data center workload. In block 694, the method may allocate communication resources between wired links 522 and wireless links 524 based on the PRL identified in block 692. This may involve retrieving the quantitative performance parameters associated with the identified PRL from the level-definition table 516. The resource allocation circuitry/logic 220 then apportions link capacity according to these specifications. For example, workloads assigned to a low-latency PRL may be preferentially routed over deterministic wired paths, while workloads with more relaxed latency budgets can be directed to wireless spectrum. Bandwidth and priority settings further influence the mix of wired and wireless resources provisioned. The output of this step is a concrete mapping of the logical workload to specific network paths and an associated allocation of link capacity.

Method 686 may then conclude at block 696 with adjusting the allocation of communication resources based on changes in workload performance requirements. In block 696 the method may dynamically adjust the resource allocations in response to changing workload requirements. Over time, the performance demands of a given workload may evolve due to shifting traffic patterns, application changes, or user needs. By continuously monitoring workload behavior and comparing observed metrics to PRL specifications, a system can detect when service tiers may need to be modified. For example, if an application previously classified for “medium” priority suddenly experiences a spike in usage, the system may proactively “upgrade” it to a higher PRL that provisions more bandwidth or lower latency. Conversely, utilization drops may trigger a downgrade to a lower PRL to optimize efficiency. This adaptive tuning allows the system to maintain service quality in the face of varying demands. The resource allocation circuitry/logic 220 works in conjunction with the workload information circuitry/logic 216 to track these changes and automatically update path assignments and capacity allocations without manual intervention.

In some aspects, data center workloads having higher performance requirement levels are allocated more wired communication resources and data center workloads having lower performance requirement levels are allocated more wireless communication resources, wherein higher performance requirement levels comprise workloads having at least one of: tighter latency constraints, increased bandwidth guarantees, reduced packet loss tolerance, or increased reliability thresholds.

In some aspects, the one or more circuits are further to: detect a change in availability of either the wireless communication links or the wired communication links; and redistribute the communication resources among active data center workloads based on their respective performance requirement levels and the detected change in availability.

In some aspects, the one or more circuits are further to: monitor at least one of latency requirements or bandwidth requirements for the data center workload; and switch the data center workload from wireless communication links to wired communication links based on the at least one of the latency requirements or the bandwidth requirements.

In view of the above, it should be appreciated that aspects of the present disclosure provide a device comprising: one or more circuits to: maintain performance profiles associated with different types of data center workloads; identify, for a data center workload, a performance requirement level from among a plurality of performance requirement levels; allocate, based on the identified performance requirement level, communication resources between wireless communication links and wired communication links for the data center workload; and adjust the allocation of communication resources based on changes in workload performance requirements. In some aspects, data center workloads having higher performance requirement levels are allocated more wired communication resources and data center workloads having lower performance requirement levels are allocated more wireless communication resources. In some aspects, the one or more circuits are further to: detect a change in availability of either the wireless communication links or the wired communication links; and redistribute the communication resources among active data center workloads based on their respective performance requirement levels and the detected change in availability. In some aspects, the one or more circuits are further to: monitor latency requirements for the data center workload; and switch the data center workload from wireless communication links to wired communication links based on the latency requirements.

In view of the above, it should be appreciated that aspects of the present disclosure provide a system comprising: a data center comprising computing devices interconnected by wired communication links and wireless communication links; and a resource management system to: receive workload information associated with data traffic in the data center; determine, based on the workload information, a resource allocation for the wireless communication links between the computing devices; configure one or more wireless communication parameters for the wireless communication links based on the determined resource allocation; and selectively route at least a portion of the data traffic through either the wireless communication links or wired communication links based on the workload information. In some aspects, the resource management system is further to: monitor performance metrics of the wireless communication links; and modify the resource allocation based on the monitored performance metrics. In some aspects, the resource management system is further to dynamically adjust the resource allocation in response to changes in the workload information.

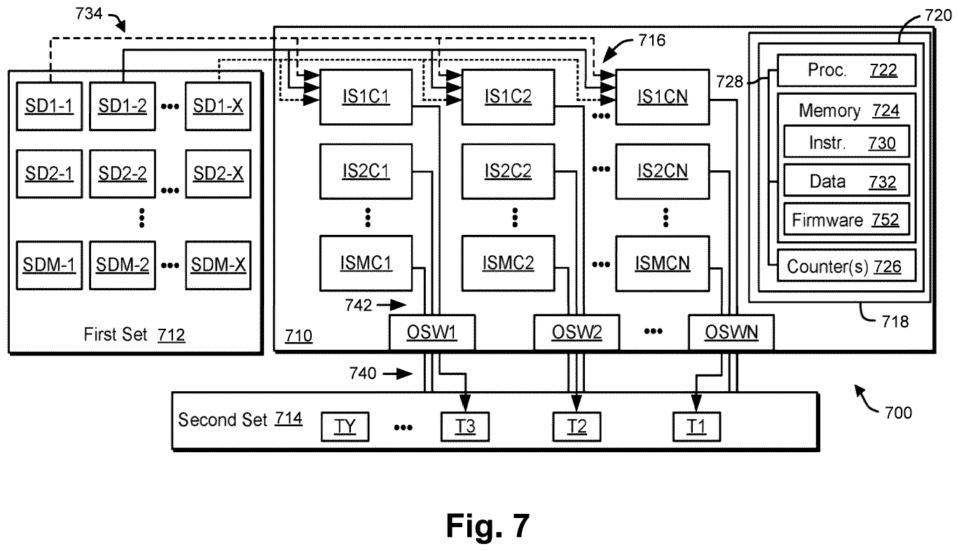

FIG. 7 illustrates a block diagram of a system 700 that includes switching circuitry 710 (sometimes referred to as a “fabric”) positioned between first and second sets 712 and 714 of devices, in accordance with at least one embodiment. By way of a non-limiting example, the system 700 may be implemented as a GPU-to-GPU link system (e.g., a NVLINK® GPU-to-GPU interconnect system) in which the switching circuitry 710 may include one or more GPU-to-GPU switches (e.g., one or more NVSWITCH™ switches). The system 700 may implement (e.g., be a component of) other systems, such as a data center, a cloud computing system, a machine learning system (e.g., utilizing one or more neural networks), an autonomous vehicle, medical imaging equipment, and/or the like.

Each of the first and second sets 712 and 714 may be implemented as a GPU, a parallel processing unit, a central processing unit (“CPU”), data processing unit (“DPU”), quantum processing units (QPUs), a controller, a switch, switching circuitry, a memory device, and/or the like. QPUs configured to perform one or more operations associated with a quantum algorithm In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with. By way of a non-limiting example, the first set 712 has been illustrated as including a number “M*X” of devices, which are illustrated as devices SD1-1 to SDM-X. However, the set 712 may include any number of devices including a single device. For ease of illustration, in FIG. 7, the devices SD1-1 to SDM-X have been illustrated as being arranged in a two-dimensional array that includes a number “M” of rows and a number “X” of columns. The second set 714 has been illustrated as including a number “Y” of devices, which are illustrated as devices T1-TY, but the second set 714 may include any number of devices including a single device. Further, one or more devices may be members of both of the sets 712 and 714. Thus, the sets 712 and 714 are not mutually exclusive and may include one or more of the same devices. Therefore, in at least one embodiment, the switching circuitry 710 may allow any of the devices SD1-1 to SDM-X in the first set 712 to communicate with any of the devices SD1-1 to SDM-X in the first set 712 and/or any of the devices T1-TY in the second set 714. Further, in at least one embodiment, the switching circuitry 710 may allow any of the devices T1-TY in the second set 714 to communicate with any of the devices T1-TY in the second set 714 and/or any of the devices SD1-1 to SDM-X in the first set 712.

The switching circuitry 710 may include a number “N” of outbound switches OSW1-OSWN, a predetermined number “M*N” of internal switches IS1C1-ISMCN, signal conductors 716, and a route block 718 that controls the operations of the internal switches IS1C1-ISMCN. The route block 718 has been illustrated as including hardware 720 that may include at least one processor 722, memory 724, and one or more counters 726. In at least one embodiment, each of the processor(s) 722 may be implemented as one or more hardware state machines, one or more microprocessors, one or more microcontrollers, one or more controllers, or the like. The memory 724 (e.g., one or more non-transitory processor-readable medium) may be implemented, for example, using volatile memory (e.g., dynamic random-access memory (“DRAM”)) and/or nonvolatile memory (e.g., a hard drive, a solid state device (“SSD”), and/or the like).

The signal conductors 716 interconnect the first set 712, the second set 714, the internal switches IS1C1-ISMCN, and the outbound switches OSW1-OSWN. In the example illustrated, the signal conductors 716 may include any number of signal conductors. The signal conductors 716 may each be implemented as a wire, a trace, and/or any other type of electrical conductor. As a non-limiting example, one or more of the signal conductors 716 may each be implemented as a wire-based serial near-range communications link. By way of another non-limiting example, one or more of the signal conductors 716 may each be implemented as a Scalable Link Interface (“SLI”).

In the embodiment illustrated, the signal conductors 716 include signal conductors 734, 740, and 742. The signal conductors 734 connect the devices SD1-1 to SDM-X to the internal switches IS1C1-ISMCN. For ease of illustration, only those of the signal conductors 734 that connect each of the devices SD1-1 to SD1-X to the internal switches IS1C1-IS1CN have been illustrated in FIG. 7. In at least one embodiment, the internal switches IS1C1-IS1CN may each include a different port that is connected to each of at least a portion of the devices SD1-1 to SDM-X (e.g., the devices SD1-1 to SD1-X, respectively) by the signal conductors 734. Similarly, the internal switches IS2C1-IS2CN may each include a different internal port that is connected to each of at least a portion of the devices SD1-1 to SDM-X (e.g., the devices SD2-1 to SD2-X, respectively) by the signal conductors 734. Further, the internal switches ISMC1-ISMCN may each include a different internal port that is connected to each of at least a portion of the devices SD1-1 to SDM-X (e.g., the devices SDM-1 to SDM-X, respectively) by the signal conductors 734.

The signal conductors 742 connect the internal switches IS1C1-ISMCN to the outbound switches OSW1-OSWN. For example, at least one of the signal conductors 742 connects each of the internal switches IS1C1-ISMC1 to the outbound switch OSW1, at least one of the signal conductors 742 connects each of the internal switches IS1C2-ISMC2 to the outbound switch OSW2, and at least one of the signal conductors 742 connects each of the internal switches IS1CN-ISMCN to the outbound switch OSWN.

The signal conductors 740 connect the outbound switches OSW1-OSWN to the devices T1-TY. The outbound switches OSW1-OSWN may each include a different port that is connected by at least one of signal conductors 740 to at least one of the devices T1-TY.

While the switching circuitry 710 has been illustrated as including the internal switches IS1C1-ISMCN, the switching circuitry 710 may include any number of internal switches including a single internal switch. Further, the internal switches IS1C1-ISMCN have been illustrated as being arranged in a two-dimensional array that includes the number “M” of rows and the number “N” of columns. However, this is not a requirement and the internal switches IS1C1-ISMCN may positioned in alternate arrangements to implement any network topology, including a three-dimensional array. One or more of the internal switches IS1C1-ISMCN may be coupled to one another. For example, from the perspective of one of the internal switches IS1C1-ISMCN, one or more of the other internal switches IS1C1-ISMCN may be one of the devices T1-TY. Further, the switching circuitry 710 may be coupled to one or more switches (e.g., switching circuitry like the switching circuitry 710) that is/are external to the switching circuitry 710. For example, one or more of the devices SD1-1 to SDM-X and/or the devices T1-TY may each be implemented as an external switch.

The route block 718 may be connected to each of the internal switches IS1C1-ISMCN and/or each of at least a portion of the signal conductors 716 by one or more buses. For example, the processor(s) 722 and the memory 724 may be connected to one another by one or more buses 728. The bus(es) 728 may also connect the processor(s) 722 and the memory 724 to the internal switches IS1C1-ISMCN and/or each of at least a portion of the signal conductors 716. The memory 724 (e.g., a non-transitory processor readable media) stores instructions 730 that are executable by the processor(s) 722, data 732, and firmware 752, which may perform monitoring and data manipulation functions. For example, the firmware 752 may instruct the hardware 720 to transition one or more of the signal conductors 716, from the active state to the inactive state and vice versa.

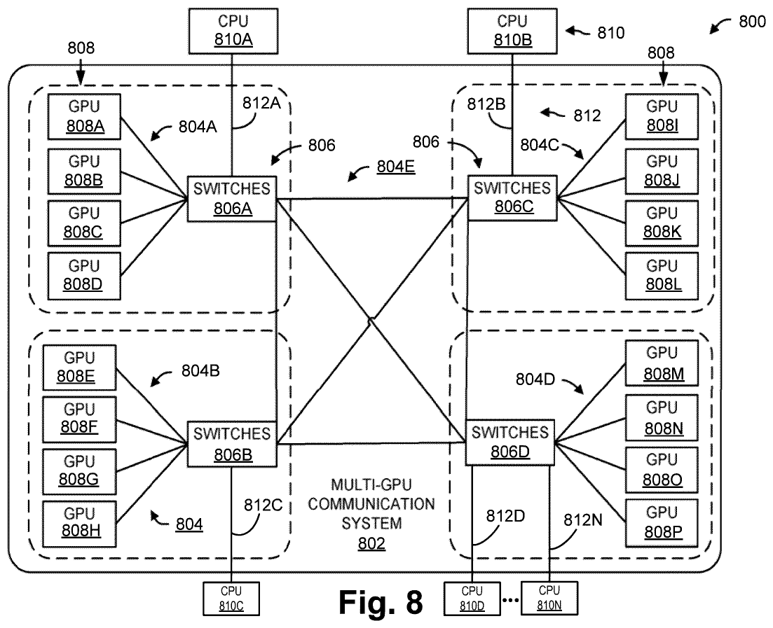

FIG. 8 illustrates a block diagram of an example system 800, in accordance with at least one embodiment. The system 800 may include, in at least one embodiment, one or more CPUs 810 connected to one or more multi-GPU communication systems (e.g., a multi-GPU communication system 802) by one or more signal conductors 812. In the embodiment illustrated in FIG. 8, the CPU(s) 810 include CPUs 810A, 810B, 810C, and 810D, which are connected to the multi-GPU communication system 802 by signal conductors 812A, 812B, 812C, and 812D, respectively. In some aspects, zero, one, or more CPUs (e.g., 810N) may be in communication with a switch (e.g., 806D) via one or more signal conductors 812N). In FIG. 8, the multi-GPU communication system 802 includes GPUs 808 connected to one another by at least one switch 806 and at least one signal conductor 804. In the embodiment illustrated, the switch(es) 806 include switches 806A-806D, the GPUs 808 include GPUs 808A-208P, and the signal conductor(s) 804 include signal conductors 804A-204E.

The system 800 may be characterized as being an example implementation of the system 700 (see FIG. 7). For example, the CPU(s) 810 and/or the GPUs 808 may be implementations of the set 712 and/or the set 714. In at least one embodiment, the CPU(s) 810 may be substantially identical to the devices SD1-1 to SDM-X and/or the devices T1-TY. In at least one embodiment, the GPUs 808 may be substantially identical to the devices SD1-1 to SDM-X and/or the devices T1-TY. By way of another non-limiting example, the signal conductor(s) 804 and/or the signal conductor(s) 812 may be implementations of the signal conductors 716. In at least one embodiment, the signal conductor(s) 804 and/or the signal conductor(s) 812 may be substantially identical to the signal conductors 716. By way of yet another non-limiting example, the switch(es) 806 may be implementations of the internal switches IS1C1-ISMCN and/or the outbound switches OSW1-OSWN. In at least one embodiment, the switch(es) 806 may be substantially identical to the switches IS1C1-ISMCN (see FIG. 7) and/or the outbound switches OSW1-OSWN.

As a non-limiting example, the signal conductors 804 may link the GPUs 808 to the switch(es) 806, and the signal conductors 812A and 812B may link the at least one of the switch(es) 806 to one or more of the CPU(s) 810. As illustrated in FIG. 8, the CPUs 810A and 810B may connected to the switches 806A and 806C, respectively, by the signal conductors 812A and 812B, respectively. In at least one embodiment, one or more of the CPU(s) 810 may be implemented as a CPU 1600 illustrated in FIG. 16. One or more of the GPUs 808 may be implemented as one or more parallel processor(s) 1412 illustrated in FIG. 14.

The multi-GPU communication system 802 may implement a form of mesh networking, which may have a local area network topology in which infrastructure nodes or devices may be connected directly, dynamically, and non-hierarchically to other nodes and may cooperate with one another to efficiently route data. Examples of infrastructure devices may include bridges, the switch(es) 806, and/or other types of infrastructure devices. The multi-GPU communication system 802 may be referred to as a GPU-to-GPU System. By way of a non-limiting example, the multi-GPU communication system 802 may be implemented as a GPU-to-GPU link system (e.g., a NVLINK® GPU-to-GPU interconnect system) in which the switch(es) 806 may include one or more GPU-to-GPU switches (e.g., one or more NVSWITCH™ switches).

The switch 806A is connected to the GPUs 808A-208D by the signal conductors 804A, the switch 806B is connected to the GPUs 808E-808H by the signal conductors 804B, the switch 806C is connected to the GPUs 808I-808L by the signal conductors 804C, and the switch 806D is connected to the GPUs 808M-808P by the signal conductors 804D. The switches 806A-806D are connected to one another by signal conductors 804E. Each of the switch(es) 806 may act as a router and/or a connection between two endpoints within the system 800 for the duration of a dedicated connection. In at least one embodiment, one or more of the switch(es) 806 may be implemented using an on-node switch architecture (e.g., one or more NVSWITCH™ switches) that connects processing units (e.g., one or more GPUs, one or more CPUs, and/or one or more other types of processor) together. The system 800 may function as part of another system, such as a data center, which incorporates hardware, networking, software, and/or libraries, and executes applications, such applications perform inferences, for example by executing Artificial Intelligence (“AI”) or machine learning models.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. The systems and methods described herein may be used in augmented reality, virtual reality, mixed reality, robotics, security and surveillance, autonomous or semi-autonomous machine applications, and/or any other technology spaces in which one or more signal conductors may have at least two different states that consume different amounts of power.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, web-hosted services or web-hosted platforms, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, systems for implementing web-hosted services (e.g., for program optimization at runtime) or web-hosted platforms (e.g., integrated development environments that include program optimization as a service), as an application programming interface (“API”) between two or more separate applications or systems, and/or other types of systems.

### Data Center

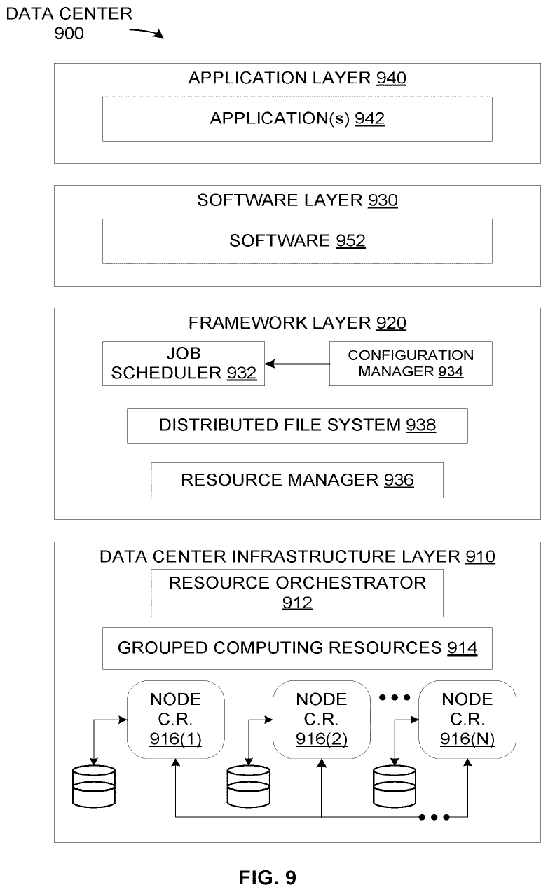

FIG. 9 illustrates an example data center 900, in accordance with at least one embodiment. In at least one embodiment, data center 900 includes, without limitation, a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (“FPGAs”), data processing units (“DPUs”) in network devices, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 912 may configure or otherwise control one or more node C.R.s 916(1)-916(N) and/or grouped computing resources 914. In at least one embodiment, resource orchestrator 912 may include a software design infrastructure (“SDI”) management entity for data center 900. In at least one embodiment, resource orchestrator 912 may include hardware, software or some combination thereof.

In at least one embodiment, as shown in FIG. 9, framework layer 920 includes, without limitation, a job scheduler 932, a configuration manager 934, a resource manager 936 and a distributed file system 938. In at least one embodiment, framework layer 920 may include a framework to support software 952 of software layer 930 and/or one or more application(s) 942 of application layer 940. In at least one embodiment, software 952 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920, including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 952 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. In at least one or more types of applications may include, without limitation, CUDA applications.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, the data center 900 may be used to implement the system 700 (see FIG. 7) and/or the system 800 (see FIG. 8). For example, the first set 712 and/or the second set 714 may include one or more of the grouped computing resources 914 and/or one or more of the C.R.s 916(1)-916(N). In at least one embodiment, one or more systems depicted in FIG. 9 are utilized to implement one or more systems and/or processes such as those described in connection with FIGS. 1-8.

It should be noted that, while example embodiments described herein may relate to a CUDA programming model, techniques described herein can be utilized with any suitable programming model, such HIP, oneAPI (e.g., using oneAPI-based programming to perform or implement a method disclosed herein), and/or variations thereof.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art. It is to be appreciated that any feature described herein can be claimed in combination with any other feature(s) as described herein, regardless of whether the features come from the same described embodiment.

What is claimed is:

1. A device comprising:
one or more circuits to:
receive workload information associated with data traffic in a data center;
determine, based on the workload information, a resource allocation for wireless communication links between computing devices in the data center;
and
selectively route at least a portion of the data traffic through either the wireless communication links or wired communication links based on the workload information.

2. The device of claim 1, wherein the workload information comprises at least one of:
processing requirements;
bandwidth requirements;
latency requirements;
power requirements;
thermal requirements; or
quality of service requirements.

3. The device of claim 1, wherein the one or more circuits are to configure one or more wireless communication parameters for the wireless communication links based on the determined resource allocation.

4. The device of claim 3, wherein the one or more wireless communication parameters comprise at least one of:
frequency allocation;
bandwidth allocation;
modulation scheme; or
transmission power.

5. The device of claim 1, wherein the one or more circuits are further to:
monitor performance metrics of the wireless communication links; and
modify the resource allocation based on the monitored performance metrics and workload requirements from the workload information.

6. The device of claim 5, wherein the performance metrics comprise at least one of:
throughput;
latency;
packet loss;
bit error rate; or
signal strength.

7. The device of claim 1, wherein to selectively route at least a portion of the data traffic, the one or more circuits are further to route traffic of a first priority type through the wired communication links and traffic of a second priority type through the wireless communication links.

8. The device of claim 7, wherein the one or more circuits are further to prioritize traffic of the second priority type by allocating additional wireless resources to communication links carrying the traffic of the second priority type.

9. The device of claim 8, wherein the one or more circuits are further to identify the traffic of the second priority type based on at least one of:
traffic type;
source application;
destination application;
workload; or
quality of service requirements.

10. The device of claim 1, wherein the computing devices comprise at least one of:
a server;
a storage device;
a network interface controller; or
a network switch.

11. The device of claim 1, wherein the one or more circuits are further to adjust the resource allocation in response to changes in the workload information.

12. The device of claim 11, wherein to dynamically adjust the resource allocation, the one or more circuits are further to reallocate wireless resources from first communication links to second communication links based on changes in workload priorities.

13. The device of claim 1, wherein the one or more circuits are further to:
maintain a mapping between wireless resources and data center workloads;
and update the mapping based on changes in the workload information.

14. The device of claim 13, wherein to update the mapping, the one or more circuits are further to reassign wireless resources based on at least one of:
workload priority changes;
network congestion;
power consumption requirements; or
performance requirements.

15. The device of claim 1, wherein the one or more circuits at least one of:
adaptively adjust wireless link capacity in real-time based on monitored performance metrics;
prioritize data traffic of a first traffic importance type by at least one of allocating additional wireless resources or routing through wired communication links based on traffic importance type;
or
seamlessly switch between wireless and wired connections in response to changing workload demands.

16. A device comprising:
one or more circuits to:
maintain a plurality of performance requirement levels associated with different types of data center workloads;
identify, for a data center workload, a performance requirement level from among the plurality of performance requirement levels;
allocate, based on the identified performance requirement level, communication resources between wireless communication links and wired communication links for the data center workload; and
adjust the allocation of communication resources based on changes in workload performance requirements.

17. The device of claim 16, wherein data center workloads having higher performance requirement levels are allocated more wired communication resources and data center workloads having lower performance requirement levels are allocated more wireless communication resources, wherein higher performance requirement levels comprise workloads having at least one of: tighter latency constraints, increased bandwidth guarantees, reduced packet loss tolerance, or increased reliability thresholds.

18. The device of claim 17, wherein the one or more circuits are further to:
detect a change in availability of either the wireless communication links or the wired communication links; and
redistribute the communication resources among active data center workloads based on their respective performance requirement levels and the detected change in availability.

19. The device of claim 17, wherein the one or more circuits are further to:
monitor at least one of latency requirements or bandwidth requirements for the data center workload; and
switch the data center workload from wireless communication links to wired communication links based on the at least one of the latency requirements or the bandwidth requirements.

20. A system comprising:
a data center comprising computing devices interconnected by wired communication links and wireless communication links; and
a resource management system to:
receive workload information associated with data traffic in the data center;
determine, based on the workload information, a resource allocation for the wireless communication links between the computing devices;
configure one or more wireless communication parameters for the wireless communication links based on the determined resource allocation; and
selectively route at least a portion of the data traffic through either the wireless communication links or wired communication links based on the workload information.

21. The system of claim 20, wherein the resource management system is further to:
monitor performance metrics of the wireless communication links; and
modify the resource allocation based on at least one of the monitored performance metrics or power consumption requirements.

22. The system of claim 20, wherein the resource management system is further to dynamically adjust the resource allocation in response to changes in the workload information.
